(19) United States
(12) Patent Application Publication
(10) Pub. No.: US 2012/0109830 A1
(43) Pub. Date: May 3, 2012

(54) APPARATUS, SYSTEM AND METHOD FOR A DECENTRALIZED SOCIAL NETWORK SYSTEM AND DECENTRALIZED PAYMENT NETWORK SYSTEM

(76) Inventor: Matt Vogel, San Francisco, CA (US)

(21) Appl. No.: 12/915,462

(22) Filed: Oct. 29, 2010

(51) Int. Cl. H04L 9/00; G06Q 40/00; G06Q 30/00; G06F 15/16; H04L 9/28

(52) U.S. Cl. 705/75; 709/204; 713/150; 705/64

(57) ABSTRACT

In the context of social networks, a social network based peer computing system, apparatus and method for a decentralized social network system and decentralized payment system in a peer to peer network environment. Two one way relationships involving a public key/private key pair allow two users of the system to establish a secure online relationship where an object can be sent securely from one user to a second user. A user having more than one device connected to the system can have information updated on one device auto migrate and replicate on remaining connected devices. This same user can also have this updated information auto migrated and replicated onto friend's devices connected to the system. A user may also establish a privacy profile wherein only certain information is auto migrated and replicated on friend's devices.

### BACKGROUND

The invention relates generally to a social network based peer computing system, apparatus and method for a decentralized social network system and decentralized payment system in a peer to peer network environment.

Files can be transferred over the internet using a variety of methods. The most common method is the client-sever model. In this model a central server sends the entire file to each client that requests it. While this model is simple to set up it faces significant problems with files that are large or very popular. These popular or large files can take up a large amount of bandwidth and end up taxing limited server resources. Consequently, a user may experience limited to no access to a desired file using this method. Furthermore, a user must ensure the file transfer is secure such that an unwanted third party does not gain access to the file being transferred or does not somehow gain access to sensitive personal information as a result of the file transfer.

In response to problems with the client-server model, another method for transferring files has recently become popular—the peer to peer network. In this network, users exchange files that are stored locally on their own computers by directly connecting with each other. Thus, by using this model a user bypasses the traditional client-server model and avoids issues of a server's resources being taxed or not having enough available bandwidth to download a desired file quickly.

In order to access a peer to peer network, various clients such as Kazaa, Gnutella and others allow a user to connect to other peers. The first iterations of these clients would typically only allow a user to connect to another single user in order to download the desired file. However, newer clients allow a user to download a file from multiple users. In peer to peer network download speeds for popular files can be quite high, but download speeds for obscure or less popular files can be quite low. However, this system can suffer from significant protocol overhead for passing search queries amongst users connected to the peer to peer network. As a result, the number of other users that can be queried can be limited. However, as with the client-server model a user must be cautious in order to ensure file transfers are secure. Furthermore, these types of services can often be a conduit for people to upload malicious software disguised as the desired file.

Another method of file distribution is Usenet binary newsgroups. In this method files are only typically available during a short period of time. This period of time can be longer depending on a variety of factors such as the user's ISP and the Usenet provider. Users that value privacy will find that Usenet is one of the more anonymous forms of file sharing. Despite these benefits user who use this method must overcome a variety of hurdles such as acclimating to a new user interface and familiarizing oneself with specific rules and procedures. Also, older or obscure files tend to be difficult to procure using this method.

BitTorrent protocol is another means of transferring files that is becoming more and more popular. This protocol allows user to distribute large amounts of data without heavily taxing their computers. In order to avoid the significant overload possible on other methods, BitTorrent enables multiple users with a desired file to simultaneously upload small pieces of the file to a requesting user. In this way BitTorrent even allows computers with small available bandwidth to participate in large data transfers. Consequently, a user can download a desired file quickly while not overloading available bandwidth. Despite these advantages, BitTorrent typically relies on a server known as a Tracker. A user's computer must communicate with the Tracker to initiate a download and once downloading the computer typically communicates with the Tracker to provide statistics and negotiate with new users. A file typically cannot be downloaded without a valid Tracker, although if the Tracker goes down after downloading has started the downloading can communicate without the Tracker.

As a result of the desire to securely transfer files over the interne, cryptography is used in many file transfers today. RSA (Rivest, Shamir and Adleman) is one algorithm for public-key cryptography. RSA involves three steps in which a key is generated, a key is encrypted, and a key is decrypted. During the key generation step a public key and private key are generated. The public key is known to everyone and is used to encrypt a message (the message can be a file, sensitive information or other pieces of information). The corresponding private key is the only key that can decrypt the public key. RSA can be implemented in a variety of environments and is today often seen used in electronic commerce protocols. SSL (Secure Socket Layer) is a protocol used to ensure secure transactions between web server and browsers. This protocol uses a third party known as a Certificate Authority to identity one end or both ends of the transaction. Inherent in this type of protocol is the generation of a public key and private key.

As relating to social networks, popular social networks such as Facebook or MySpace rely on a central database to provide social connectivity. Users must create a profile on these sites and after profile creation a user will typically populate their profile with personal information such as relationship status or pictures. Data added to a user's profile is stored and maintained on the social network's central database. In order to connect with other friends on the social network users must search the social network's central database (server) to find these friends. As previously explained, a server's resources are limited and bandwidth limitations can cause slow or unresponsive queries. Furthermore, issues of data privacy and identity theft are increasingly in the media. As related to social networks, a user may be giving up their ownership rights to any information uploaded to the social network's database. Furthermore, breaches in security and sharing of personal information to unwanted third parties are additional concerns that must be dealt with.

Consequently, there exists today a need for a means of implementing a social network based peer computing system, apparatus and method for a decentralized social network system and decentralized payment system in a peer to peer network environment. Such a system circumvents bandwidth, resource and security issues involving a social network with a central database. Furthermore, such a system ensures secure file transfer by using a public key/private key pair.

### SUMMARY OF THE INVENTION

The present invention is directed toward an apparatus, system and method for a decentralized social network system and decentralized payment network system in a peer to peer network environment.

According to one embodiment, a social network based peer computing system comprises a plurality of peer nodes configured to implement a peer to peer environment on a network according to a peer to peer platform; wherein peer nodes connected to said social network based peer computing system are capable of sending and receiving data from other devices connected to the social network based peer computing system; wherein at least a subset of the plurality of peer nodes is locally configured to store data specified by a user; and wherein a first user of at least one peer node establishes a relationship with a second user using at least one peer node, said relationship established upon the first user sending a request to the second user, said request consisting of information selected from the group consisting of a file, text string, and data in a structured format; wherein upon receipt of the request, said second user can elect to accept or decline said request, wherein upon acceptance of said request a relationship is established between the first user and second user that allows said first user and said second user to share store data stored on the peer node of the first user and second user.

According to another aspect of the previous embodiment, a social network based peer computing system, comprises one or more of peer nodes configured to implement a peer to peer environment on a network according to a peer to peer platform; wherein peer nodes connected to said social network based peer computing system are capable of sending and receiving data from other devices connected to the social network based peer computing system; wherein at least a subset of the one or more peer nodes is locally configured to store data specified by a user without the use of a central server; wherein a first user has one or more devices connected to one or more peer nodes, and wherein said first user updates stored data comprising a profile, wherein upon updating said profile, the profile is automatically migrated and replicated to said first user's remaining devices that are connected to one or more peer nodes; wherein a first user of at least one or more devices establishes a one way relationship with a second user using at least one peer node, said one way relationship established upon the first user directly sending a request to the second user without the use of a central server, said request consisting of text string information comprised of a file, text string identifier, and data in a structured format, wherein said text string information is selected from the group consisting of the first user's IP address, the first user's public key identifier, and a first user-selected message; wherein upon receipt of the request, said second user can elect to accept or decline said request, wherein upon response to said request a second one way relationship is established; and wherein upon acceptance of said request a relationship is established between the first user and the second user that allows said first user and said second user to share stored data stored on the device of the first user and peer node of the second user to create a public key, private key pair.

According to various aspects of the previous embodiment, the public key, private key pair includes the second one way relationship that comprises a private key response to said request to create a trust relationship by downloading a file. In various aspects, the embodiment also includes the social network based peer computing system wherein the peer nodes comprise a memory for storing data, a processor capable of executing processor readable code, and a communications port for transmitting and receiving data from other peer nodes in said social network based peer computing system. In other aspects, the first and second one way relationships converts a text string into a memory structure that creates an array to send instructions to one or more peer nodes. In another configuration, the stored data comprises a structured format wherein said structured format is in the form of processor readable code. In other certain aspects, the text string information includes a first and second dynamic IP address and said one or more devices are selected from the group consisting of a computer, personal digital assistant, smart phone, and mobile phone. In yet other configurations of the embodiment, a first user looks up a second user by looking up said second user's public key, said public key is contained within a file and wherein said file consists of the second user's public key, the second user's IP address and a text string information, and upon sending of a first encrypted message and a corresponding first user privacy profile, said second user establishes a second one way relationship between said second user and said first user, in a social network based peer computing system 100, that comprises one or more of peer nodes configured to implement a peer to peer environment on a network according to a peer to peer platform; wherein peer nodes connected to said social network based peer computing system are capable of sending and receiving data from other devices connected to the social network based peer computing system; wherein at least a subset of the one or more peer nodes is locally configured to store data specified by a user without the use of a central server; wherein a first user has one or more devices connected to one or more peer nodes, and wherein said first user updates stored data comprising a profile, wherein upon updating said profile, the profile is automatically migrated and replicated to said first user's remaining devices that are connected to one or more peer nodes; wherein a first user of at least one or more devices establishes a one way relationship with a second user using at least one peer node, said one way relationship established upon the first user directly sending a request to the second user without the use of a central server, said request consisting of text string information comprised of a file, text string identifier, and data in a structured format, wherein said text string information is selected from the group consisting of the first user's IP address, the first user's public key identifier, and a first user-selected message; wherein upon receipt of the request, said second user can elect to accept or decline said request, wherein upon response to said request a second one way relationship is established; and wherein upon acceptance of said request a relationship is established between the first user and the second user that allows said first user and said second user to share stored data stored on the device of the first user and peer node of the second user to create a public key, private key pair. In yet another configuration of the previous embodiment, a first user has at least two devices connected to one or more peer nodes, wherein at least one of said two devices has established a public key/private key pair relationship with a second user, wherein said second user has at least two devices connected to one or more peer nodes, wherein at least one of said two devices of said second user is participating in the public key/private key pair relationship with said first user, wherein upon a first user updating store data on at least one device said store data is automatically migrated and replicated to at least one device of said second user via the public key/private key pair relationship, wherein upon replication to at least one device of said second user, said one device of said second user automatically migrates and replicates said store data to remaining devices of said second user connected to one or more peer nodes.

According to another embodiment, a two way communication is transmitted between a first user and a second user, wherein a first user sends an unencrypted public key along with an encrypted private key and a corresponding object to a second user, said encrypted private key and corresponding object locally stored on a device belonging to said first user, wherein said private key and corresponding object are encrypted during transmission to said second user. In certain aspects, the embodiment includes a configuration wherein a second user sends an unencrypted public key along with an encrypted private key and corresponding object to a first user, said encrypted private key and corresponding object locally stored on a device belong to said second user, wherein said private key and corresponding object are encrypted during transmission to said first user.

According to an embodiment, a public key/private key pairing for a relationship wherein a first user and a second user communicate by sharing the same public key/private key pair with each other, wherein upon sharing the same public key/private key pair, the first user and second use may send encrypted messages to each other. In another aspect, the encrypted message is an object consisting of a user's IP address and a text string.

According to an embodiment, a social network peer to peer structure, comprises one or more devices associated with a first user, the one or more devices associated with a first user each having a root level object, the one or more root level objects that are associated with the one or more devices associated with a first user each include a first device identified as a device 0, a second device identified as a device 1, and sequentially in the same pattern for the first user total associated devices in the peer to peer network, the one or more root level objects further comprising a device information level including Internet Protocol (IP) addresses for each corresponding device other than the device 0 and friend information including a first friend identified as friend 0, a second friend identified as friend 1, and sequentially in the same pattern for the first user total associated devices not including the device 0 and the first user total associated friends not including the friend 0.

According to other various aspects of the embodiment, a social network peer to peer structure, comprises one or more devices associated with a first user, the one or more devices associated with a first user each having a root level object, the one or more root level objects that are associated with the one or more devices associated with a first user each include a first device identified as a device 0, a second device identified as a device 1, and sequentially in the same pattern for the first user total associated devices in the peer to peer network, the one or more root level objects further comprises a device information level including Internet Protocol (IP) addresses for each corresponding device other than the device 0 and friend information including a first friend identified as friend 0, a second friend identified as friend 1, and sequentially in the same pattern for the first user total associated devices not including the device 0 and the first user total associated friends not including the friend 0 and one or more device information data strings including device specific information corresponding to each first user device wherein the device information data string includes one or more data elements selected from the group consisting of reference device IP address, reference device protocol version, and connection information, one or more associated friends corresponding to a first user wherein said one or more associated friends comprises corresponding one or more device information data strings.

According to other various aspects of the embodiment, a social network peer to peer structure, comprises one or more devices associated with a first user, the one or more devices associated with a first user each having a root level object, the one or more root level objects that are associated with the one or more devices associated with a first user each include a first device identified as a device 0, a second device identified as a device 1, and sequentially in the same pattern for the first user total associated devices in the peer to peer network, the one or more root level objects further comprises a device information level including Internet Protocol (IP) addresses for each corresponding device other than the device 0 and friend information including a first friend identified as friend 0, a second friend identified as friend 1, and sequentially in the same pattern for the first user total associated devices not including the device 0 and the first user total associated friends not including the friend 0 and one or more device information data strings including device specific information corresponding to each first user device wherein the device information data string includes one or more data elements selected from the group consisting of reference device IP address, reference device protocol version, and connection information, one or more associated friends corresponding to a first user wherein said one or more associated friends comprises corresponding one or more device information data strings wherein one or more privacy setting filters associated with the one or more device information data strings, the one or more data elements, and the one or more corresponding friends, the one or more first user devices that are synchronized to each other wherein said one or more first user devices share each data change with each other said one or more first user devices to replicate said data elements and device information.

According to other various aspects of the embodiment, a social network peer to peer structure, comprises one or more devices associated with a first user, the one or more devices associated with a first user each having a root level object, the one or more root level objects that are associated with the one or more devices associated with a first user each include a first device identified as a device 0, a second device identified as a device 1, and sequentially in the same pattern for the first user total associated devices in the peer to peer network, the one or more root level objects further comprises a device information level including Internet Protocol (IP) addresses for each corresponding device other than the device 0 and friend information including a first friend identified as friend 0, a second friend identified as friend 1, and sequentially in the same pattern for the first user total associated devices not including the device 0 and the first user total associated friends not including the friend 0 and one or more device information data strings including device specific information corresponding to each first user device wherein the device information data string includes one or more data elements selected from the group consisting of reference device IP address, reference device protocol version, and connection information, one or more associated friends corresponding to a first user wherein said one or more associated friends comprises corresponding one or more device information data strings wherein one or more privacy setting filters associated with the one or more device information data strings, the one or more data elements, and the one or more corresponding friends, the one or more first user devices that are synchronized to each other wherein said one or more first user devices share each data change with each other said one or more first user devices to replicate said data elements and device information and wherein a first user with a multiplicity of devices is connected to one or more peer nodes, wherein each of said multiplicity of devices has established a public key/private key pair relationship with a second user, wherein said second user has at a multiplicity of devices connected to one or more peer nodes, wherein each of said multiplicity of devices is participating in the public key/private key pair relationship with each of said multiplicity of devices of said first user, wherein upon a first user updating stored data on at least one device said stored data is automatically migrated and replicated to the remaining multiplicity of devices of said first user, and wherein upon being updated each of said multiplicity of devices of said first user automatically migrates said stored data to each multiplicity of devices of said second user wherein said store data is then replicated on each of said multiplicity of devices of said second user.

According to other various aspects of the embodiment, a social network peer to peer structure, comprises one or more devices associated with a first user, the one or more devices associated with a first user each having a root level object, the one or more root level objects that are associated with the one or more devices associated with a first user each include a first device identified as a device 0, a second device identified as a device 1, and sequentially in the same pattern for the first user total associated devices in the peer to peer network, the one or more root level objects further comprises a device information level including Internet Protocol (IP) addresses for each corresponding device other than the device 0 and friend information including a first friend identified as friend 0, a second friend identified as friend 1, and sequentially in the same pattern for the first user total associated devices not including the device 0 and the first user total associated friends not including the friend 0 and one or more device information data strings including device specific information corresponding to each first user device wherein the device information data string includes one or more data elements selected from the group consisting of reference device IP address, reference device protocol version, and connection information, one or more associated friends corresponding to a first user wherein said one or more associated friends comprises corresponding one or more device information data strings wherein one or more privacy setting filters associated with the one or more device information data strings, the one or more data elements, and the one or more corresponding friends, the one or more first user devices that are synchronized to each other wherein said one or more first user devices share each data change with each other said one or more first user devices to replicate said data elements and device information and wherein a first user with a multiplicity of devices is connected to one or more peer nodes, wherein each of said multiplicity of devices has established a public key/private key pair relationship with a second user, wherein said second user has at a multiplicity of devices connected to one or more peer nodes, wherein each of said multiplicity of devices is participating in the public key/private key pair relationship with each of said multiplicity of devices of said first user, wherein upon a first user updating stored data on at least one device said stored data is automatically migrated and replicated to the remaining multiplicity of devices of said first user, and wherein upon being updated each of said multiplicity of devices of said first user automatically migrates said stored data to each multiplicity of devices of said second user wherein said store data is then replicated on each of said multiplicity of devices of said second user and wherein the public key/private key pair relationship establishes a two way communication between a first user and a second user, said users each including a data string comprising a public key, private key and an object, said public keys transmitted unencrypted and said private key and object combined in an encrypted transmission but held locally.

According to other various aspects of the embodiment, the above social network peer to peer structure is provided wherein a packet sniffer may only access the unencrypted public key portion of said two way communication. In other various aspects the social network peer to peer structure is provided wherein a first user has established a custom privacy setting wherein said custom privacy setting enables a first user to filter what portions of said first users updated stored data are automatically migrated to friends of said first user. Another configuration of the embodiment includes the above social network peer to peer structure wherein upon receipt of said first encrypted message and said first user privacy profile, said second user establishes a second one way relationship between said second user and said first user and a corresponding second user privacy profile.

According to another embodiment, a method for making a friend comprises the following steps: generating a new public key/private key pair object representation and adding it to a first user's friend list; attaching a first user's device information to a copy of the public key/private key pair object representation; providing said object representation to a second user friend, said object representation selected from the list comprising a text file, an email, and a user-selected format; providing an acceptance; importing said object representation by a second user friend into a custom application wherein said second user friend now has said new public key/private key pair object representation; and sending said object representation from a second user friend's first device to all remaining devices belonging to a second user.

According to another embodiment, a method for securely sending an object from a first user to a second user comprises the following steps: formatting an object comprised of user-selected data wherein said user-selected data is selected from the group consisting of a first user's IP address, a shared private key, and a text string containing user-selected text to create a packet; encrypting said object with a shared private key; sending the encrypted object to a second user as a packet; receiving of said encrypted object by a second user; looking up by said second user a public key of said first user, said public corresponding to the encrypted object send to said second user by said first user; decrypting of said encrypted object by said second user; examining the decrypted user-selected data by said second user; and replacing preexisting data with the newly received and decrypted user selected data such that said second user has updated data in accordance with the decrypted user-selected data.

According to another embodiment, a computer implemented method including computer-usable readable storage medium having computer-readable program code embodied therein for causing a computer system to perform a method of providing a social network based peer computing system includes steps for configuring a plurality of peer nodes to implement a peer to peer environment on a network according to a peer to peer platform; connecting peer nodes to said social network based peer computing system that are capable of sending and receiving data from other devices connected to the social network based peer computing system; locally configuring at least a subset of the plurality of peer nodes to store data specified by a user without the use of a central server; automatically migrating and replicating to a first user's remaining devices when a first user has one or more devices connected to one or more peer nodes, and wherein said first user updates and profiles are automatically migrated and replicated to said first user's remaining devices; establishing a one way relationship between a first user of at least one or more devices and a second user corresponding to at least one peer node, said one way relationship established upon the first user directly sending a request to the second user without the use of a central server, said request consisting of text string information, wherein said text string information is selected from the group consisting of IP address, public key identifier, and a user-selected message, wherein upon receipt of the request, said second user can elect to accept or decline said request, wherein upon response to said request a second one way relationship is established; and establishing a relationship upon acceptance of said request between the first user and the second user that allows said first user and said second user to share stored data stored on the device of the first user and peer node of the second user to create a public key, private key pair.

According to another embodiment, a computer implemented method including computer-usable readable storage medium having computer-readable program code embodied therein for causing a computer system to perform a method of providing a social network based peer computing system includes steps for configuring a plurality of peer nodes to implement a peer to peer environment on a network according to a peer to peer platform; connecting peer nodes to said social network based peer computing system that are capable of sending and receiving data from other devices connected to the social network based peer computing system; locally configuring at least a subset of the plurality of peer nodes to store data specified by a user without the use of a central server; automatically migrating and replicating to a first user's remaining devices when a first user has one or more devices connected to one or more peer nodes, and wherein said first user updates and profiles are automatically migrated and replicated to said first user's remaining devices; establishing a one way relationship between a first user of at least one or more devices and a second user corresponding to at least one peer node, said one way relationship established upon the first user directly sending a request to the second user without the use of a central server, said request consisting of text string information, wherein said text string information is selected from the group consisting of IP address, public key identifier, and a user-selected message, wherein upon receipt of the request, said second user can elect to accept or decline said request, wherein upon response to said request a second one way relationship is established; and establishing a relationship upon acceptance of said request between the first user and the second user that allows said first user and said second user to share stored data stored on the device of the first user and peer node of the second user to create a public key, private key pair, further comprises a step for providing said first and second one way relationships that convert one or more text strings into a memory structure that creates an array to send instructions to one or more peer nodes.

According to other aspects of the embodiment, a computer implemented method including computer-usable readable storage medium having computer-readable program code embodied therein for causing a computer system to perform a method of providing a social network based peer computing system includes steps for configuring a plurality of peer nodes to implement a peer to peer environment on a network according to a peer to peer platform; connecting peer nodes to said social network based peer computing system that are capable of sending and receiving data from other devices connected to the social network based peer computing system; locally configuring at least a subset of the plurality of peer nodes to store data specified by a user without the use of a central server; automatically migrating and replicating to a first user's remaining devices when a first user has one or more devices connected to one or more peer nodes, and wherein said first user updates and profiles are automatically migrated and replicated to said first user's remaining devices; establishing a one way relationship between a first user of at least one or more devices and a second user corresponding to at least one peer node, said one way relationship established upon the first user directly sending a request to the second user without the use of a central server, said request consisting of text string information, wherein said text string information is selected from the group consisting of IP address, public key identifier, and a user-selected message, wherein upon receipt of the request, said second user can elect to accept or decline said request, wherein upon response to said request a second one way relationship is established; and establishing a relationship upon acceptance of said request between the first user and the second user that allows said first user and said second user to share stored data stored on the device of the first user and peer node of the second user to create a public key, private key pair, further comprises a step for providing said first and second one way relationships that convert one or more text strings into a memory structure that creates an array to send instructions to one or more peer nodes. In other various aspects of the embodiment, the computer implemented method further comprises a step for configuring at least a subset of the plurality of peer nodes wherein said at least a subset of the plurality of peer nodes are locally configured to store data specified by a user.

According to another embodiment, A computer-implemented platform including computer-usable readable storage medium having computer-readable program code embodied therein for causing a computer system to perform steps to allow a first user to establish a relationship with a second user in a social network based peer computing system comprises a custom computer platform, a plurality of peer nodes configured to implement a peer to peer environment on a network according to a peer to peer platform; wherein peer nodes connected to said social network based peer computing system are capable of sending and receiving data from other devices connected to the social network based peer computing system; wherein at least a subset of the plurality of peer nodes is locally configured to store data specified by a user; and wherein a first user of a first peer node establishes a relationship with a second user using a second peer node, said relationship established upon the first user sending a request to the second user; wherein upon receipt of the request, said second user can elect to accept or decline said request, wherein upon acceptance of said request a relationship is established between the first user and second user that allows said first user and said second user to share store data stored on the first and second peer nodes of the first user and second users; and wherein a one-way relationship between the first user and the second user comprises a public key and a private key pair and wherein the public key and private key one-way relationship pair converts a text string into a memory structure and the pair creates a corresponding array.

According to another embodiment, a computer-implemented method for providing a social network based peer computing system, the method comprises providing a plurality of peer nodes configured to implement a peer to peer environment on a network according to a peer to peer platform; sending and receiving data from one or more devices wherein peer nodes are connected to the social network based peer computing system; locally configuring a subset of a plurality of peer nodes wherein at least a subset of the plurality of peer nodes stored data specified by a user; and establishing a one-way relationship, public key and private key pair between a first user of a first peer node and a second user using a second peer node, said relationship established upon the first user sending a request to the second user wherein upon receipt of the request, said second user can elect to accept or decline said request, wherein upon acceptance of said request a second one-way relationship is established between the first user and second user that allows said first user and said second user to share store data stored on the first and second peer nodes of the first user and second users; and wherein a second one-way relationship between the first user and the second user comprises a public key and a private key pair and wherein the public key and private key one-way relationship pair converts a text string into a memory structure and the pair creates a corresponding array to create a first set of unmodified query pairs of electronic digital information request results to be stored in a data repository that is not located in a central server and may be configured locally; and providing a user feedback modified second set of request query pairs of electronic digital information request results to be displayed.

According to another embodiment, a computer system for providing a social network based peer computing system, based on a first user's request secure query pair and decrypted system settings in a heterogeneous enterprise search environment, comprises a computer that is coupled to a digital telecommunications network by a digital telecommunications link to form a network of said computers; a computer readable storage medium; one or more sequences of computer program instructions stored in the electronic digital memory which, when executed, cause the computer to perform the steps of providing a first set of unmodified document query pairs of electronic digital information search results to be stored in a data repository; providing a user feedback modified second set of document query pairs of electronic digital information search results to be displayed; creating a social networking secure peer to peer array algorithm as a combination function comprising a plurality of step functions, said step functions specified by different user feature sets of sub-query user personalized preferences; and replicating the first user's query pair and decrypted system settings in a heterogeneous enterprise search environment with one or more associated devices to create one public/private key pair, one or more devices corresponding to one or more persons and a plurality of attempted connections.

According to another aspect of the embodiment, the computer system for providing a social network based peer computing system, based on a first user's request secure query pair and decrypted system settings in a heterogeneous enterprise search environment, comprises a computer that is coupled to a digital telecommunications network by a digital telecommunications link to form a network of said computers; an electronic digital memory in the computer; one or more sequences of computer program instructions stored in the electronic digital memory which, when executed, cause the computer to perform the further comprises a system in which the first user and an associated second user in a friend relationship with a payment system, allows both users sets of one or more devices to trade transaction data; and transaction data comprising a payment amount, transaction identifier, and corresponding bank account information necessary for completing an e-commerce online, encrypted transaction. In other various aspects, the embodiment further comprises merchant banking information to a purchaser wherein the merchant and purchaser are in a public key/private key, friend relationship; merchant banking data from the purchaser's one or more synchronized devices to the purchaser's bank; a deposit into the merchant's associated friend transaction bank account, using the associated e-commerce friend transaction data; a transaction identifier string of characters randomly generated by the merchant device; an associated transaction description and other text containing fields placed to be immediately accessible by the merchant device to verify that a deposit has been made for the current friend transaction; and a verification of the transaction utilizing the corresponding transaction identifier and purchase amount to determine that the transaction is complete.

According to another aspect of the embodiment, the computer system for providing a social network based peer computing system, based on a first user's request secure query pair and decrypted system settings in a heterogeneous enterprise search environment, comprises a computer that is coupled to a digital telecommunications network by a digital telecommunications link to form a network of said computers; an electronic digital memory in the computer; one or more sequences of computer program instructions stored in the electronic digital memory which, when executed, cause the computer to perform the further comprises a system in which the first user and an associated second user in a friend relationship with a payment system, allows both users sets of one or more devices to trade transaction data; and transaction data comprising a payment amount, transaction identifier, and corresponding bank account information necessary for completing an e-commerce online, encrypted transaction. In other various aspects, the embodiment further comprises merchant banking information to a purchaser wherein the merchant and purchaser are in a public key/private key, friend relationship; merchant banking data from the purchaser's one or more synchronized devices to the purchaser's bank; a deposit into the merchant's associated friend transaction bank account, using the associated e-commerce friend transaction data; a transaction identifier string of characters randomly generated by the merchant device; an associated transaction description and other text containing fields placed to be immediately accessible by the merchant device to verify that a deposit has been made for the current friend transaction; and a verification of the transaction utilizing the corresponding transaction identifier and purchase amount to determine that the transaction is complete. In another various aspect of the embodiment, the computer system for providing a social network based peer computing system further comprises user selected electronic digital information query results to be displayed; and one or more social network based peer computing system algorithms as combination functions that comprise one or more security factors, said security factors specified by different user selected weighting values corresponding to a plurality of user personalized preferences and one or more privacy profiles, said privacy profiles specified by various user selected weighting values corresponding to one or more privacy profiles.

According to another embodiment, a computer-implemented method for providing a social network based peer computing system algorithms based on customer's settings in a heterogeneous enterprise search environment system, the method comprises providing user selected electronic digital information search results to be displayed; creating a social network based peer computing system algorithm as a combination function comprising a plurality of security factors, said security factors specified by different user selected weights corresponding to a plurality of user personalized preferences; defining said security factors to indicate user defined document attributes and user defined preference weighting values; first classifying a first grouping of security factors in a subset known to the search system; first classifying a second grouping of security factors in a subset unknown to the search system, wherein said first and second grouping of security factors determine whether said security factor is known to the search system; second classifying a first grouping of security factors in a subset that corresponds to whether said social network based peer computing system is dependent on said query; creating a social networking secure peer to peer array algorithm as a combination function comprising a plurality of step functions, said step functions specified by different user feature sets of sub-query user personalized preferences; replicating the first user's query pair and decrypted system settings in a heterogeneous enterprise search environment with one or more associated devices to create one public/private key pair, one or more devices corresponding to one or more persons and a plurality of attempted connections; providing merchant banking information to a purchaser wherein the merchant and purchaser are in a public key/private key, friend relationship; sending merchant banking data from the purchaser's one or more synchronized devices to the purchaser's bank; making a deposit into the merchant's associated friend transaction bank account, using the associated e-commerce friend transaction data; randomly generating a transaction identifier string of characters by the merchant device; associating an transaction description and other text containing fields placed to be immediately accessible by the merchant device to verify that a deposit has been made for the current friend transaction; and verifying of the transaction utilizing the corresponding transaction identifier and purchase amount to determine that the transaction is complete.

According to another embodiment, a system for providing a social network based peer computing system modeling in an object-oriented software environment, comprises a custom computer platform, a plurality of peer nodes configured to implement a peer to peer environment on a network according to a peer to peer platform; wherein peer nodes connected to said social network based peer computing system are capable of sending and receiving data from other devices connected to the social network based peer computing system; wherein at least a subset of the plurality of peer nodes is locally configured to store data specified by a user; and wherein a first user of a first peer node establishes a relationship with a second user using a second peer node, said relationship established upon the first user sending a request to the second user; wherein upon receipt of the request, said second user can elect to accept or decline said request, wherein upon acceptance of said request a relationship is established between the first user and second user that allows said first user and said second user to share store data stored on the first and second peer nodes of the first user and second users; and wherein a one-way relationship between the first user and the second user comprises a public key and a private key pair and wherein the public key and private key one-way relationship pair converts a text string into a memory structure and the pair creates a corresponding array one or more devices associated with a first user, the one or more devices associated with a first user each having a root level object, the one or more root level objects that are associated with the one or more devices associated with a first user each include a first device identified as a device 0, a second device identified as a device 1, and sequentially in the same pattern for the first user total associated devices in the peer to peer network, the one or more root level objects further comprising a device information level including Internet Protocol (IP) addresses for each corresponding device other than the device 0 and friend information including a first friend identified as friend 0, a second friend identified as friend 1, and sequentially in the same pattern for the first user total associated devices not including the device 0 and the first user total associated friends not including the friend 0, one or more device information data strings including device specific information corresponding to each first user device wherein the device information data string includes one or more data elements selected from the group consisting of reference device IP address, reference device protocol version, and connection information, one or more associated friends corresponding to a first user wherein said one or more associated friends comprises corresponding one or more device information data strings, wherein a first user with a multiplicity of devices is connected to one or more peer nodes, wherein each of said multiplicity of devices has established a public key/private key pair relationship with a second user, wherein said second user has at a multiplicity of devices connected to one or more peer nodes, wherein each of said multiplicity of devices is participating in the public key/private key pair relationship with each of said multiplicity of devices of said first user, wherein upon a first user updating stored data on at least one device said stored data is automatically migrated and replicated to the remaining multiplicity of devices of said first user, and wherein upon being updated each of said multiplicity of devices of said first user automatically migrates said stored data to each multiplicity of devices of said second user wherein said store data is then replicated on each of said multiplicity of devices of said second user, a processor operable to execute instructions contained in computer program code, at least one computer readable medium including steps for implementing a social network based peer computing system, a computer program code providing programming language that is general purpose and object oriented, and said computer program code for executing the mathematical algorithm represented using the programming language and solving the mathematical expressions.

According to another embodiment, a computer readable medium for a social network peer to peer structure, comprises (a) program code for sending a public key unencrypted; (b) program code for holding locally a private key and object to be encrypted during transmission; (c) program code for associating a first user with a second user wherein said first user has one or more corresponding devices and said second user has one or more corresponding devices; (d) program code for associating device information for each user and corresponding devices of said user; (e) program code for including one or more data elements to a corresponding device information data string; (f) program code for generating a new public key/private key pair object representation and adding it to a first user's friend list; (g) program code for attaching a first user's device information to a copy of the public key/private key pair object representation; (h) program code for providing said object representation to a second user friend, said object representation selected from the list comprising a text file, an email, and a user-selected format; (i) program code for providing an acceptance; (j) program code for importing said object representation by a second user friend into a custom application wherein said second user friend now has said new public key/private key pair object representation; and (k) program code for sending said object representation from a second user friend's first device to all remaining devices belonging to a second user.

According to another embodiment, A secure system for record synchronization of independent databases in an application platform peer to peer computer system, comprises a properly formatted file of secure alternative identifiers in a special table associated with a properly formatted file of friend requests that is performed in batch by a markup language web service, a first user and an associated second user in a friend relationship with a payment system, allowing both users sets of one or more devices to trade transaction data, transaction data comprising a payment amount, transaction identifier, and corresponding bank account information necessary for completing an e-commerce online, encrypted transaction, and merchant banking information to a purchaser wherein the merchant and purchaser are in a public key/private key, friend relationship; merchant banking data from the purchaser's one or more synchronized devices to the purchaser's bank; a deposit into the merchant's associated friend transaction bank account, using the associated e-commerce friend transaction data; a transaction identifier string of characters randomly generated by the merchant device; an associated transaction description and other text containing fields placed to be immediately accessible by the merchant device to verify that a deposit has been made for the current friend transaction; and a verification of the transaction utilizing the corresponding transaction identifier and purchase amount to determine that the transaction is complete.

According to another embodiment, one or more processor readable storage devices having processor readable code embodied on at least one processor readable storage device, said processor readable code for programming at least one processor to perform a method of making a friend comprises generating a new public key/private key pair object representation and adding it to a first user's friend list; attaching a first user's device information to a copy of the public key/private key pair object representation; providing said object representation to a second user friend, said object representation selected from the list comprising a text file, an email, and a user-selected format; providing an acceptance; importing said object representation by a second user friend into a custom application wherein said second user friend now has said new public key/private key pair object representation; and sending said object representation from a second user friend's first device to all remaining devices belonging to a second user providing a menu to a user in a machine readable markup language; receiving one or more requests from the user for one or more encryption protected personal identifiers related to said user's one or more privacy filter data personal identifiers; fetching said one or more encryption protected personal identifiers related to said user's one or more privacy filter data identifiers from a database; formatting the one or more encryption protected personal identifiers related to said user's one or more privacy filter data identifiers into markup language, and; transmitting the markup language to the user wherein the one or more encryption protected personal identifiers related to said user's one or more privacy filter data identifiers comprises one or more aggregated database objects including one or more encryption protected personal identifiers related to said user's one or more privacy filter data identifiers, one or more third party augmented payment system database object tables, and at least one lockout security module wherein said at least one lockout security module is associated with at least one third party augmented payment system table.

According to another embodiment, a computer-implemented apparatus for providing a method of making a friend, said apparatus comprises a processor; an input device coupled to said processor; a memory coupled to said processor; an output device; and an execution engine including a method for providing method of making a friend comprising the following steps: providing a plurality of peer nodes configured to implement a peer to peer environment on a network according to a peer to peer platform; sending and receiving data from one or more devices wherein peer nodes are connected to the social network based peer computing system; locally configuring a subset of a plurality of peer nodes wherein at least a subset of the plurality of peer nodes stored data specified by a user; and establishing a one-way relationship, public key and private key pair between a first user of a first peer node and a second user using a second peer node, said relationship established upon the first user sending a request to the second user wherein upon receipt of the request, said second user can elect to accept or decline said request, wherein upon acceptance of said request a second one-way relationship is established between the first user and second user that allows said first user and said second user to share store data stored on the first and second peer nodes of the first user and second users; and wherein a second one-way relationship between the first user and the second user comprises a public key and a private key pair and wherein the public key and private key one-way relationship pair converts a text string into a memory structure and the pair creates a corresponding array to create a first set of unmodified query pairs of electronic digital information request results to be stored in a data repository that is not located in a central server and may be configured locally; and providing a user feedback modified second set of request query pairs of electronic digital information request results to be displayed.

According to another embodiment, a customizable application system comprises a secure peer to peer computer system application execution system for public key/private key social network and payment system configured to support preventing the submittal of the private key identifier to retrieve the properly formatted and encrypted locally held personal identifier to create a private key/public key pair, friend relationship; a user interface generator operable to generate a secure synchronized data exchange application user interface including a secure data exchange interface element, the secure synchronized data exchange application user interface being configured for delivery to the user over a peer to peer computer network, the secure synchronized data exchange application element including a retrieve secure privacy filter identifier command; metadata characterizing the one or more augmented friend relationship identifier table objects to create the one or more properly formatted personal identifier commands; wherein the user interface is operable to display an amount of data in response to a previously executed query, a processor; an input device coupled to said processor; a memory coupled to said processor; an output device; and an execution engine including a method for providing a method of making a friend comprising the following steps: providing a plurality of peer nodes configured to implement a peer to peer environment on a network according to a peer to peer platform; sending and receiving data from one or more devices wherein peer nodes are connected to the social network based peer computing system; locally configuring a subset of a plurality of peer nodes wherein at least a subset of the plurality of peer nodes stored data specified by a user; and establishing a one-way relationship, public key and private key pair between a first user of a first peer node and a second user using a second peer node, said relationship established upon the first user sending a request to the second user wherein upon receipt of the request, said second user can elect to accept or decline said request, wherein upon acceptance of said request a second one-way relationship is established between the first user and second user that allows said first user and said second user to share store data stored on the first and second peer nodes of the first user and second users; and wherein a second one-way relationship between the first user and the second user comprises a public key and a private key pair and wherein the public key and private key one-way relationship pair converts a text string into a memory structure and the pair creates a corresponding array to create a first set of unmodified query pairs of electronic digital information request results to be stored in a data repository that is not located in a central server and may be configured locally; and providing a user feedback modified second set of request query pairs of electronic digital information request results to be displayed. In other various aspects, the embodiment further comprises the customizable application system wherein the secure synchronized data exchange application user interface is configured for display at the secure synchronized data exchange application client using standard web browsing protocols.

According to another embodiment, a three party social network arrangement comprises three relationship identifiers including a first user and a second user that share a private key-public key pair in a friend relationship and relate generally to a third party that does not share the public key-private key pair and is therefore not known to the first and second user and wherein the first and second user root level objects include a friends list and wherein propagating and replicating the three party social network comprises performing a query to search for common public keys using a party's device information in a first party and second user relationship. In other aspects the embodiment may variously include a query of device information data from one or more root level objects and associated nested friends lists in additional related level objects wherein the related objects create a third level list of contacts to invite as a new friend, a relationship identifier wherein a third party is unknown to the first and second user in the absence of a common public key and wherein a third party may not access or identify an individual in the social network, a three party social network arrangement wherein each user has no link to a central database, server, and no account thereon and wherein each device in the social network contains a complete copy of the entire social network including its my device object data, a three party social network arrangement wherein a friend or employee will have complete, real time contact information for every other friend or employee in the closed environment, and a three party social network arrangement wherein an organization chart is automatically generated and a complete suite of possible document, media, sharing and messaging is available in a fully implemented, private, secure, social network in the closed, enterprise environment.

In another embodiment, a method for mapping an organizational chart, comprises traversing a complete social network; evaluating one or more root level objects to identify common public key contact data; evaluating one or more additional related level objects wherein the related objects create a third level list of contacts to invite as a new friend; skipping friend relationships that have previously been evaluated in a higher level object when compared to the current level in a nested friends list; skipping common public keys in a contact that has previously been evaluated in a higher level object; parsing one or more objects to replace an existing friend object with an object received; automatically generating an organization chart from the one or more friend relationships in an enterprise environment; and replicating and synchronizing said organizational chart with one or more root level objects, one or more additional related level objects to comprise a complete copy of the entire enterprise social network.

### BRIEF DESCRIPTION OF THE DRAWINGS

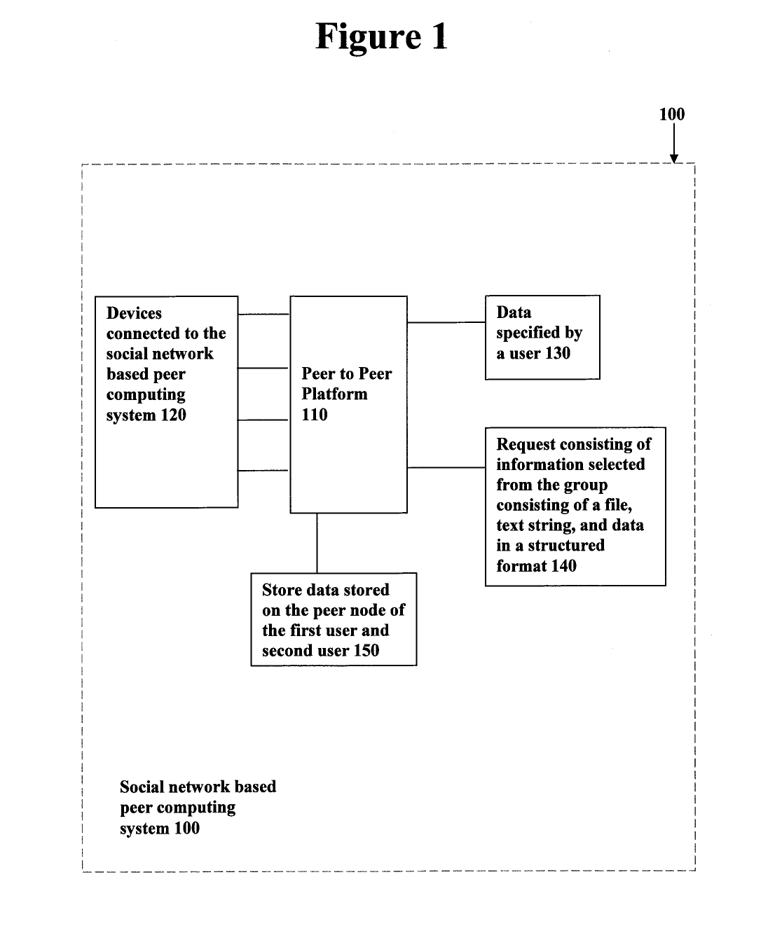

In one embodiment as shown in FIG. 1, a social network based peer computing system is illustrated.

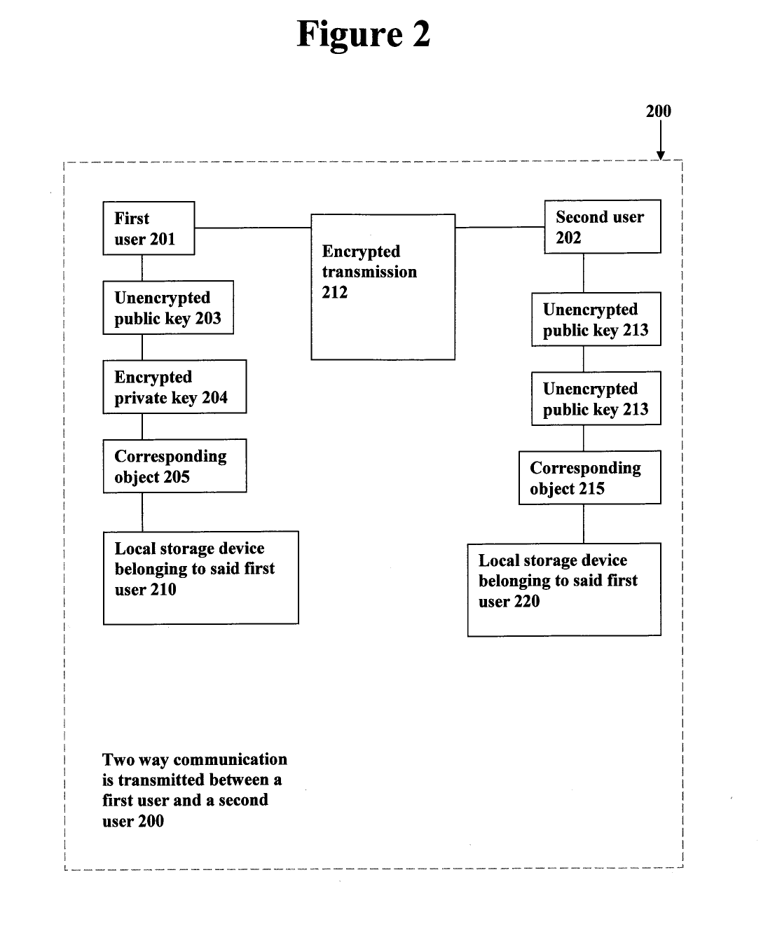

In one embodiment in FIG. 2, a two way communication between a first user and a second user is shown.

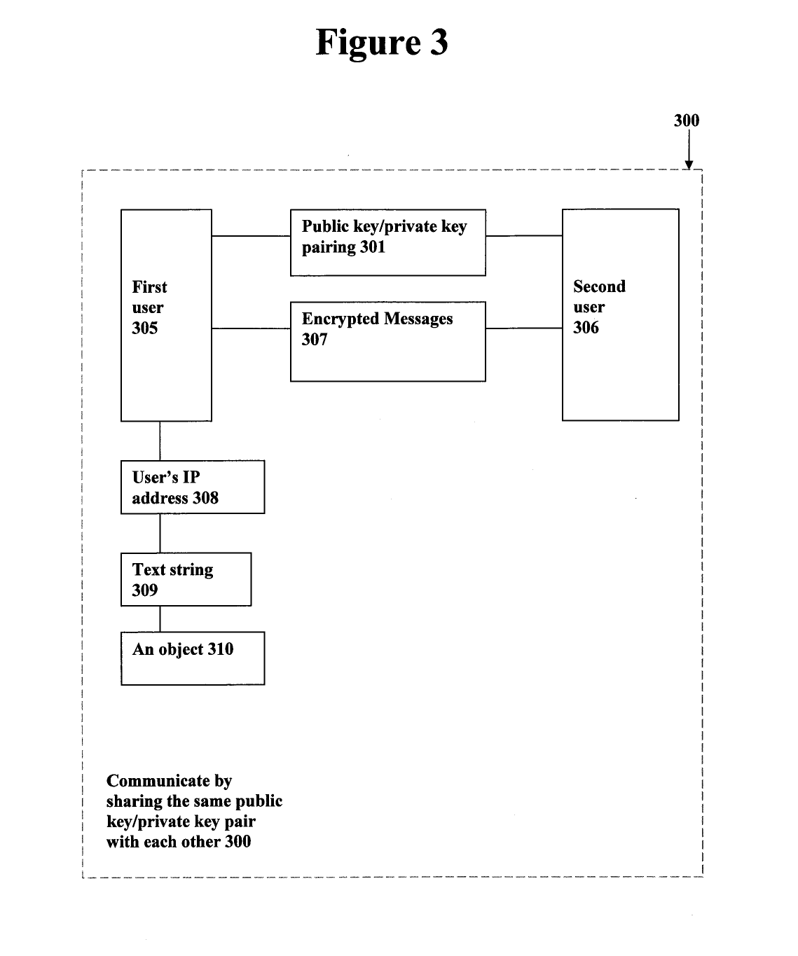

In another embodiment in FIG. 3, a public key/private key pairing for a relationship is shown.

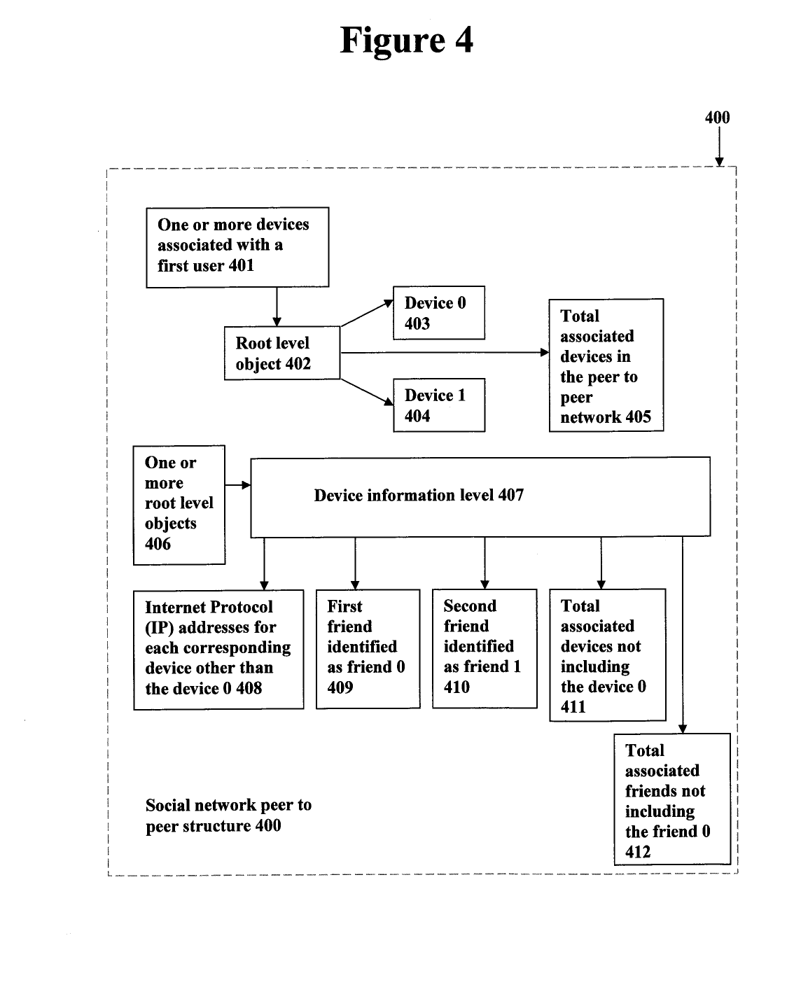

In another embodiment in FIG. 4, a social network peer to peer structure is shown.

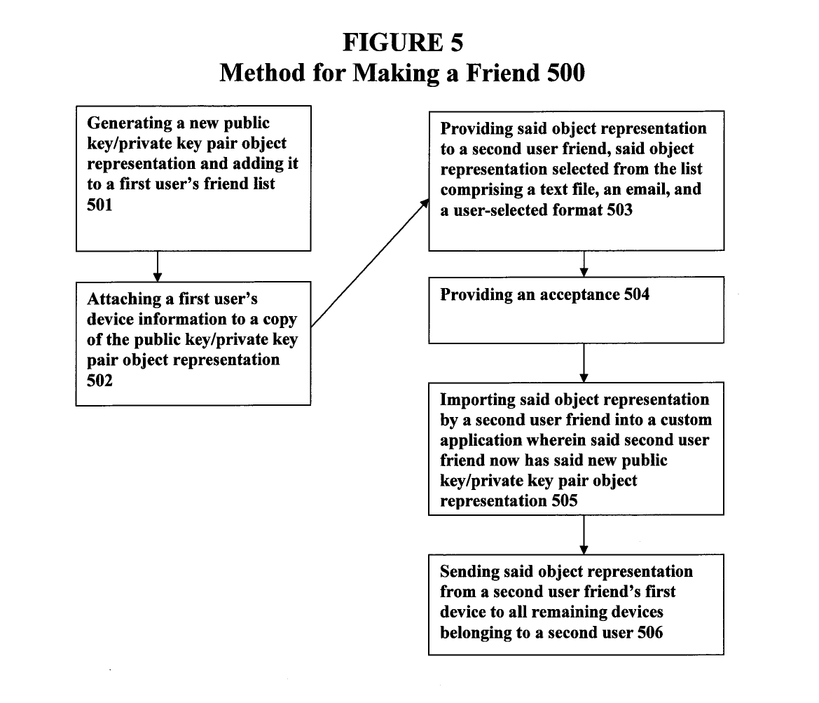

In the embodiment of FIG. 5, a method for making a friend comprising the steps shown.

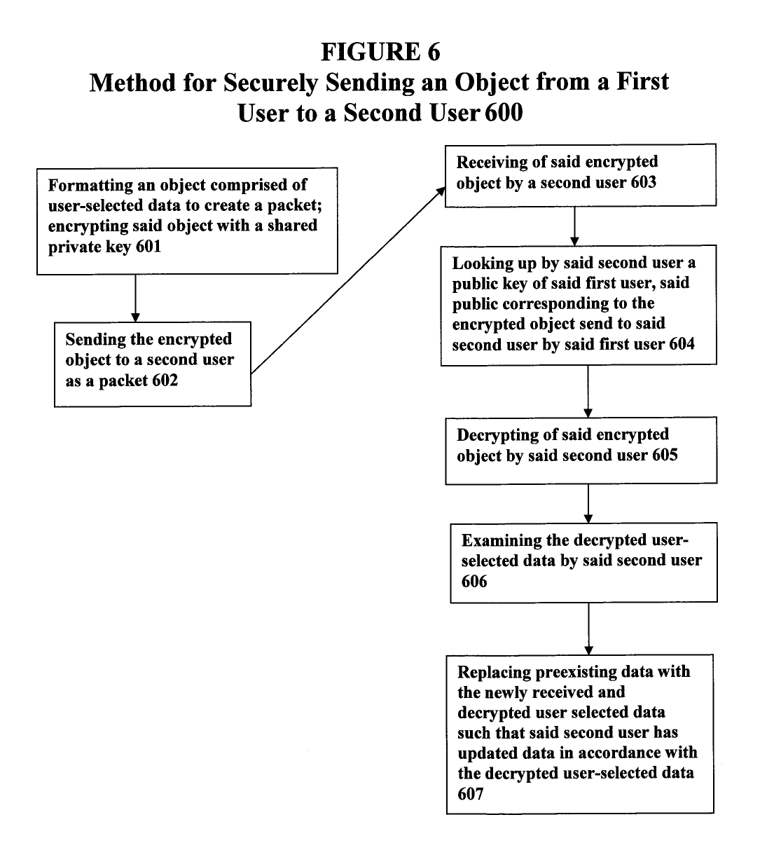

In another embodiment of FIG. 6, a method for securely sending an object from a first user to a second user is shown.

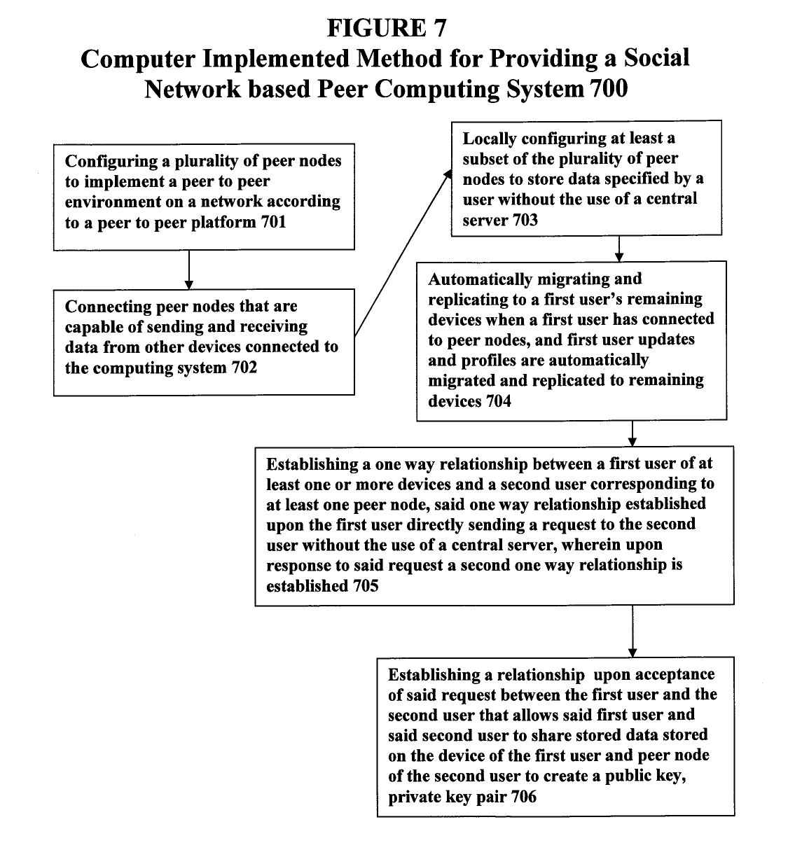

In another embodiment of FIG. 7, a computer implemented method including computer-usable readable storage medium having computer-readable code embodied therein for causing a computer system to perform a method of providing a social network based peer computing system is shown.

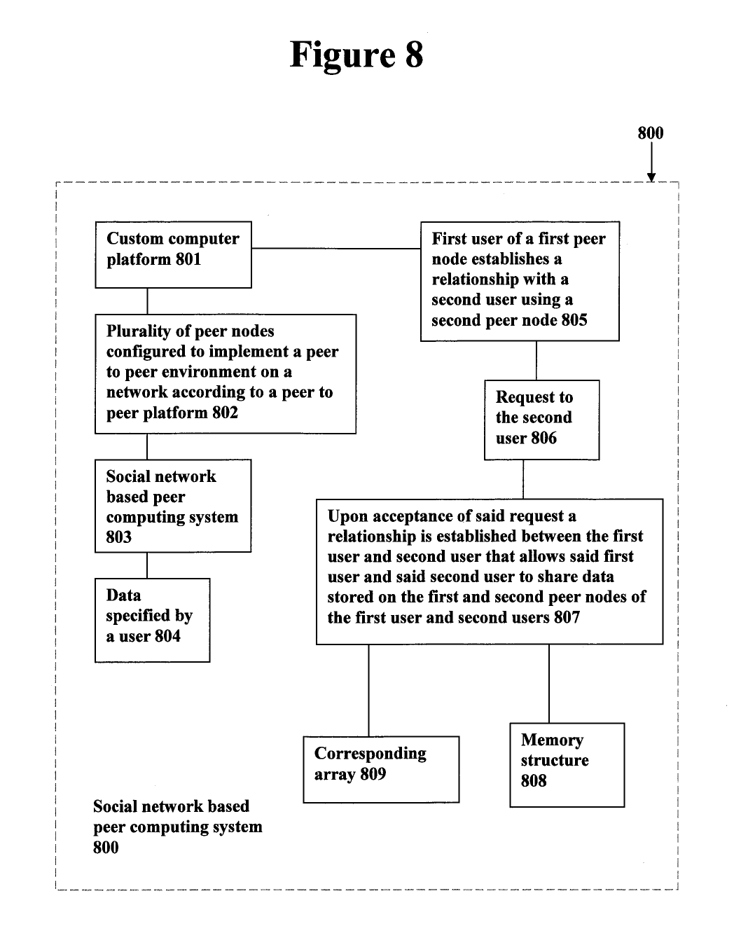

In another embodiment of FIG. 8, a computer implemented platform including computer-usable readable storage medium having computer-readable program code embodied therein for causing a computer system to perform steps to allow a first user to establish a relationship with a second user in a social network based peer computer system is shown.

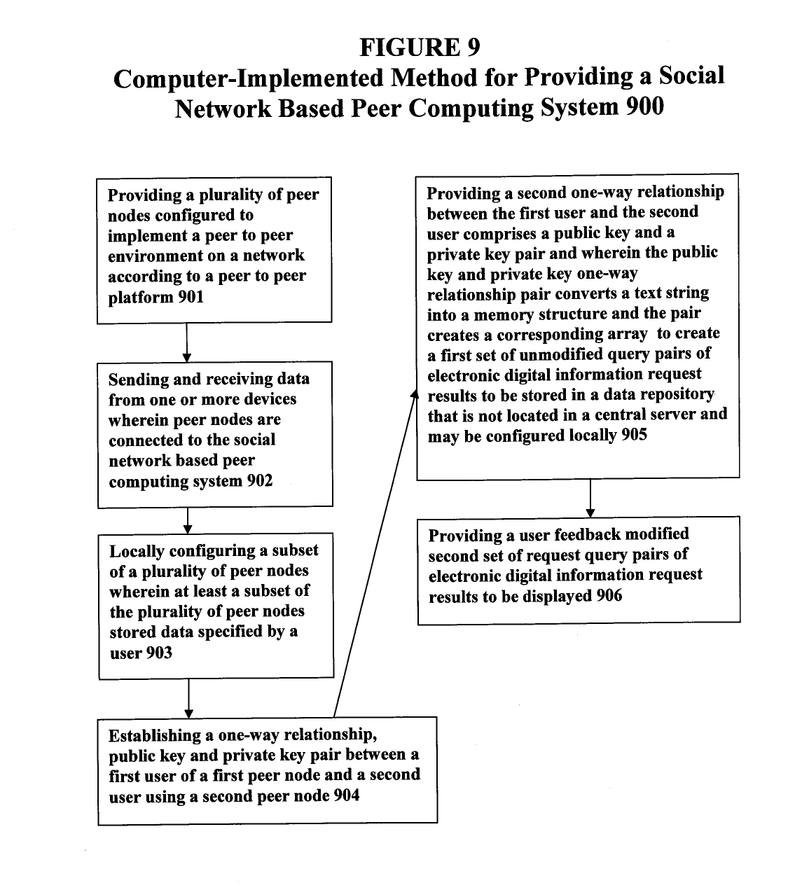

In another embodiment of FIG. 9, a computer implemented method for providing a social network based peer computing system is shown.

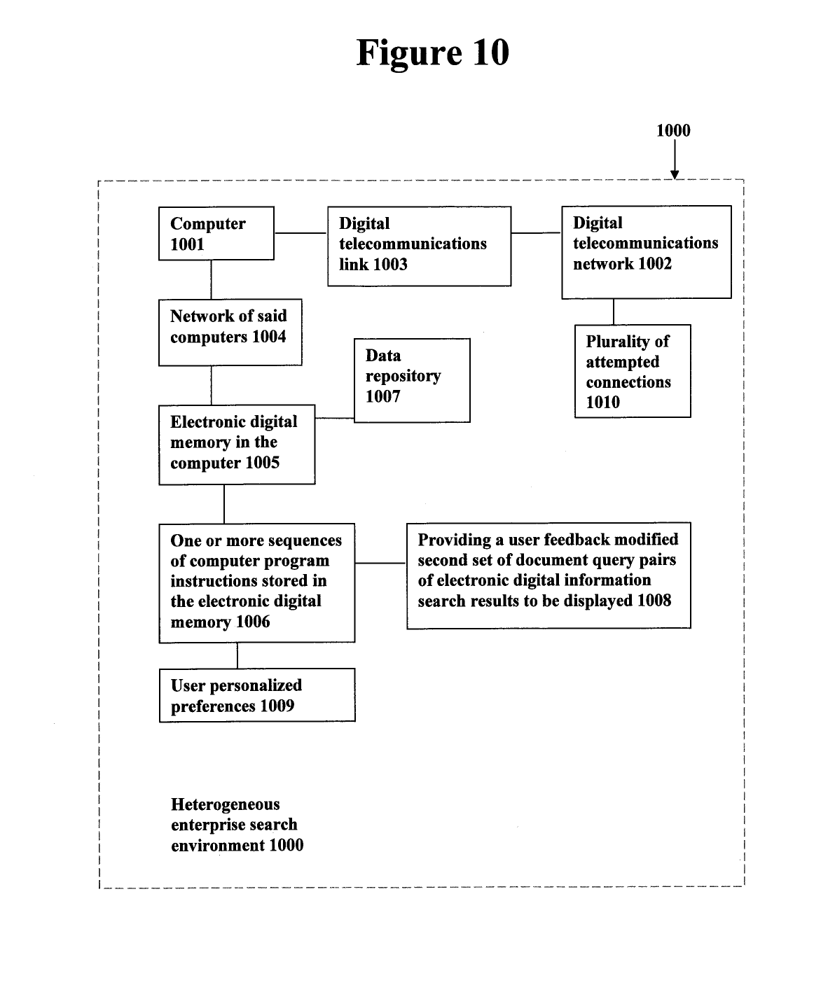

In another embodiment of FIG. 10, a computer system for providing a social network based peer computing system, based on a first user's secure query pair request and decrypted system settings in a heterogeneous enterprise peer to peer environment is shown.

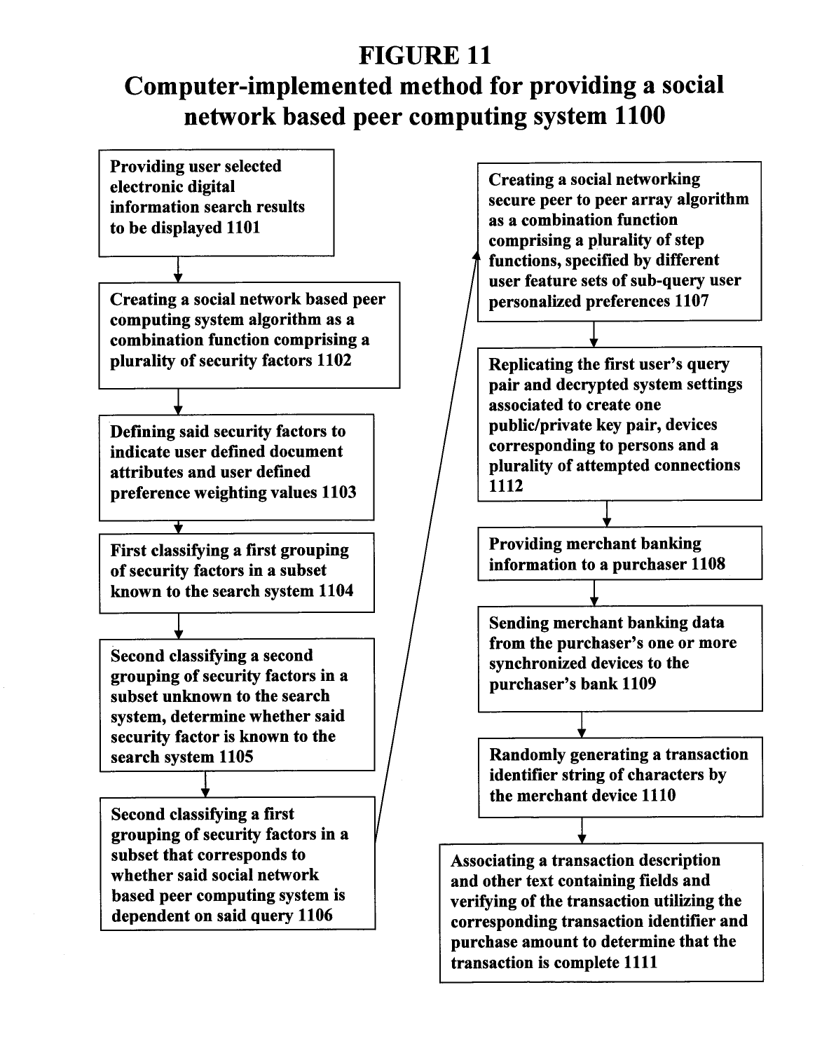

In another embodiment of FIG. 11, a computer implemented method for providing a social network based computing system algorithms based on customer's settings in a heterogeneous enterprise peer to peer environment system is shown.

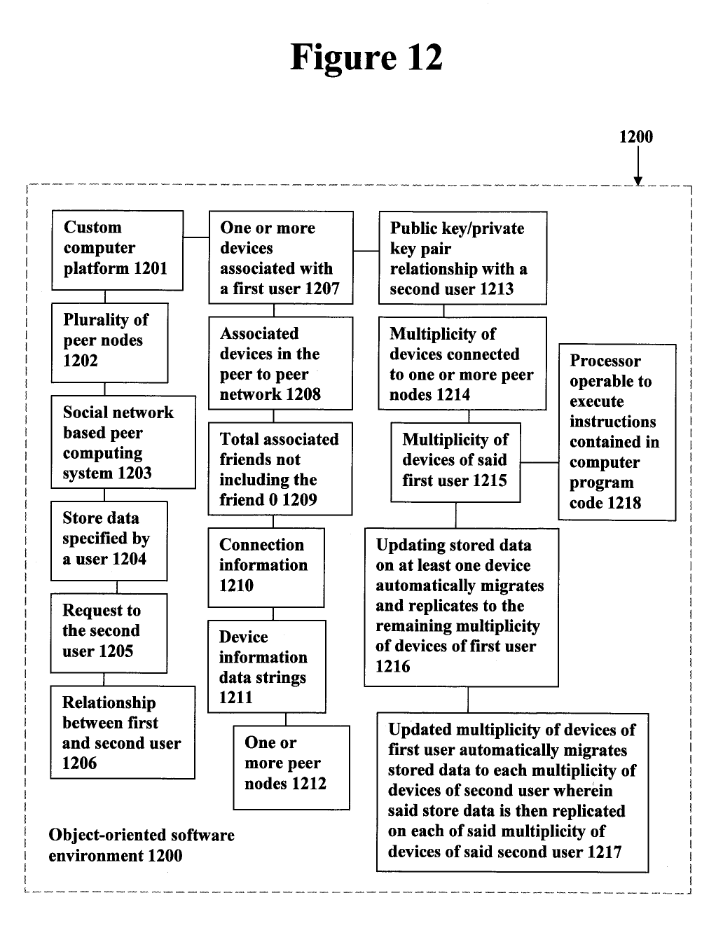

In another embodiment of FIG. 12, a system for providing a social network based computing system modeling in an object-oriented software environment is shown.

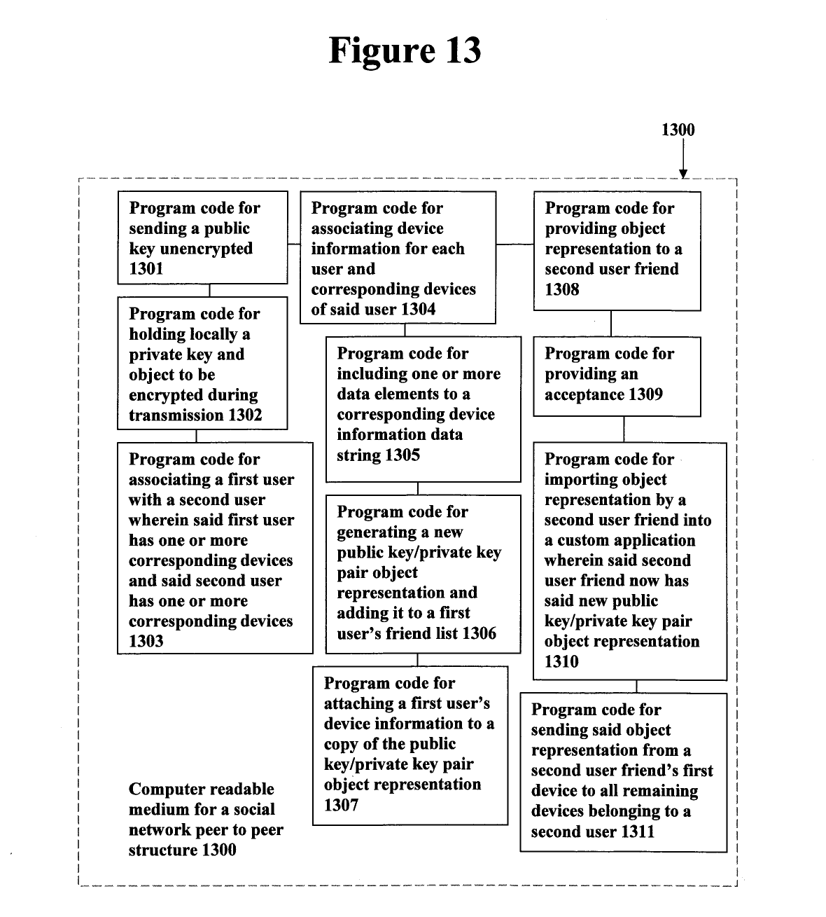

In another embodiment of FIG. 13, a computer readable medium for a social network peer to peer structure is shown.

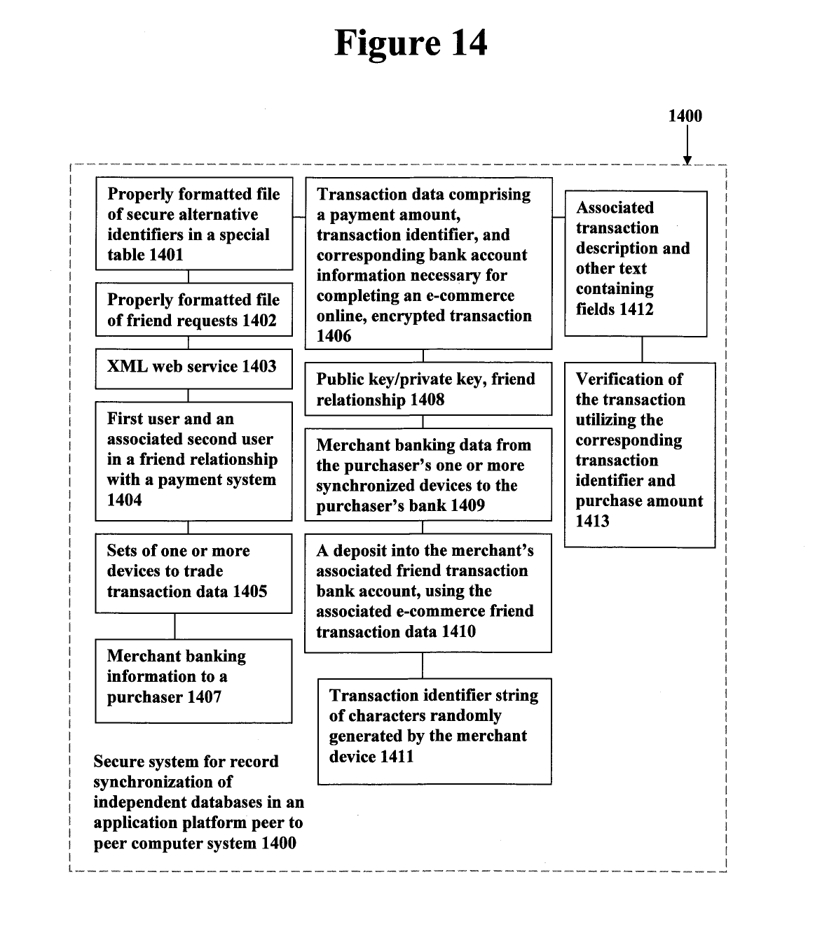

In another embodiment of FIG. 14, a secure system for record synchronization of independent databases in an application platform peer to peer computer system is shown.

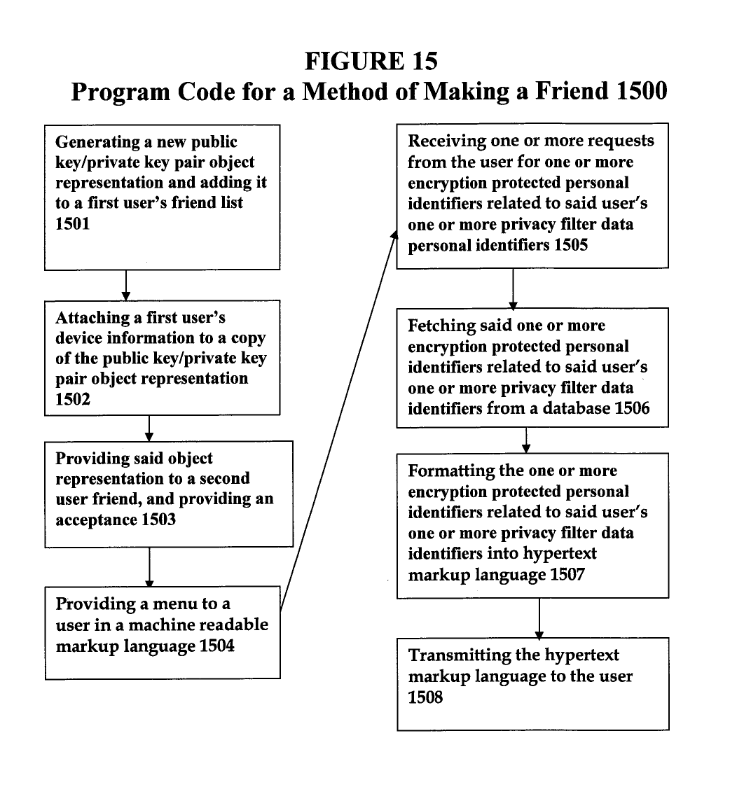

In another embodiment of FIG. 15, one or more processor readable storage devices having processor readable code embodied on at least one processor readable storage device, for programming at least one processor to perform a method of making a friend is shown.

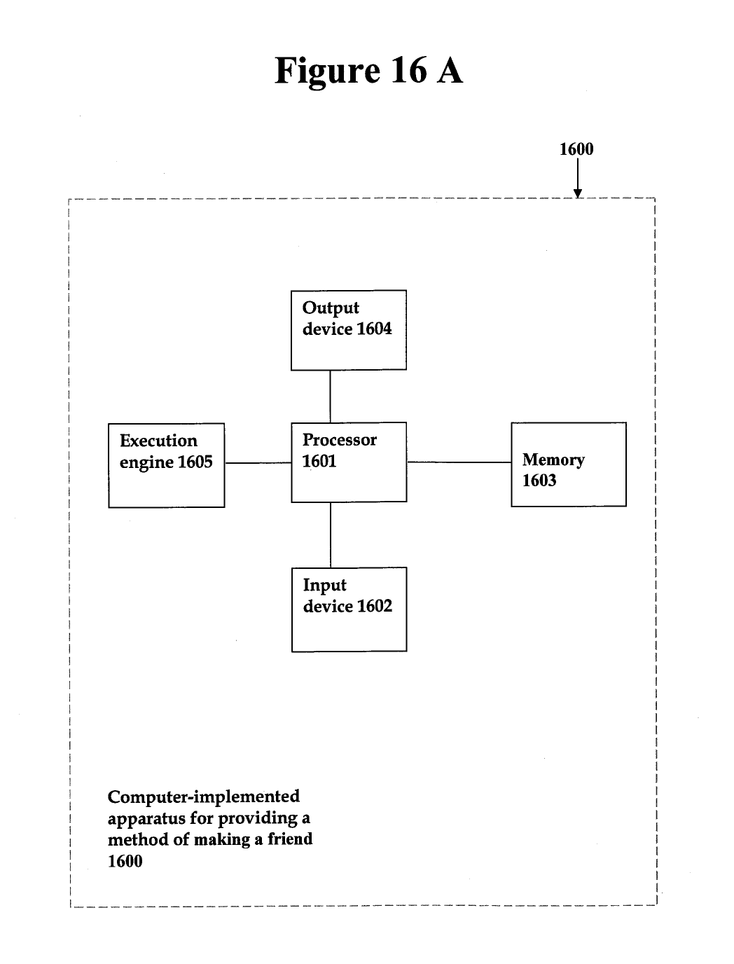

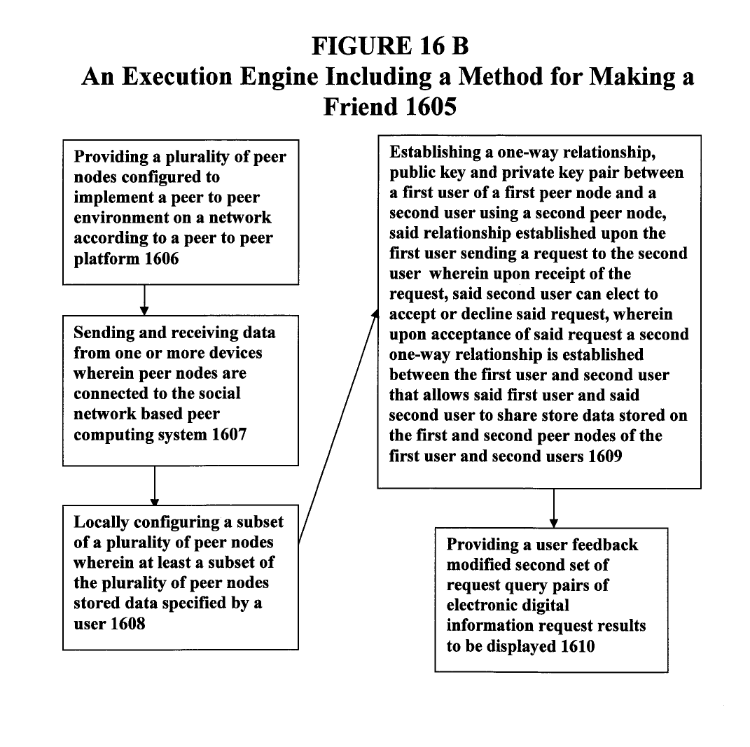

In another embodiment of FIG. 16, a computer implemented apparatus for providing a method of making a friend is shown.

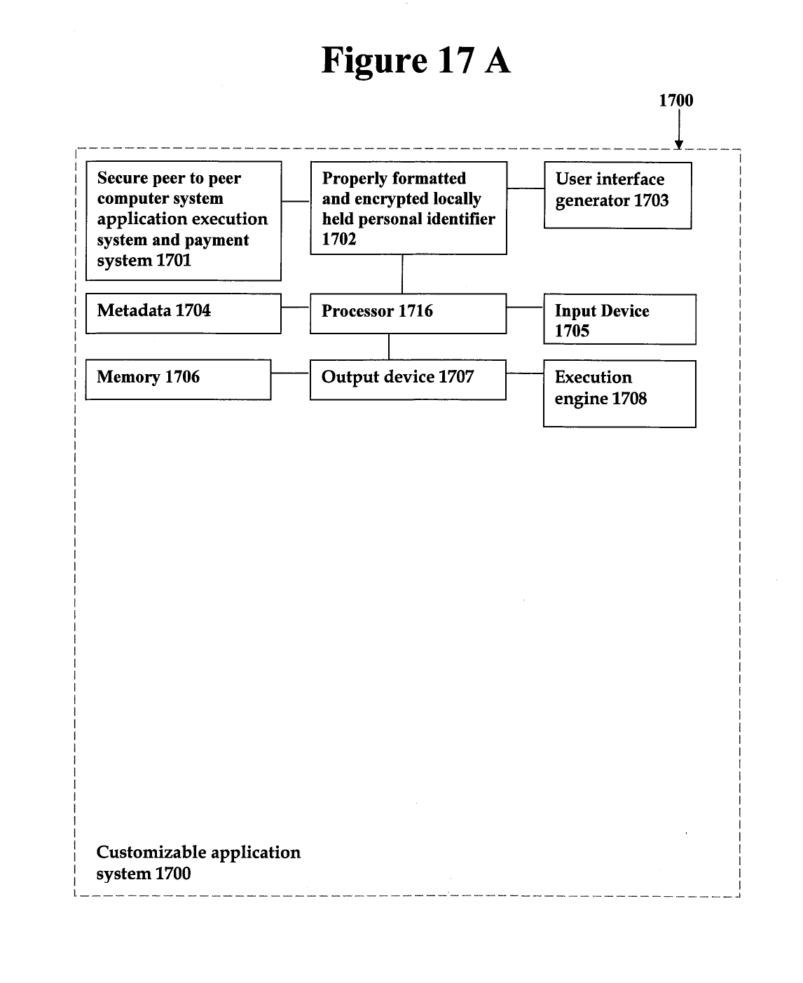

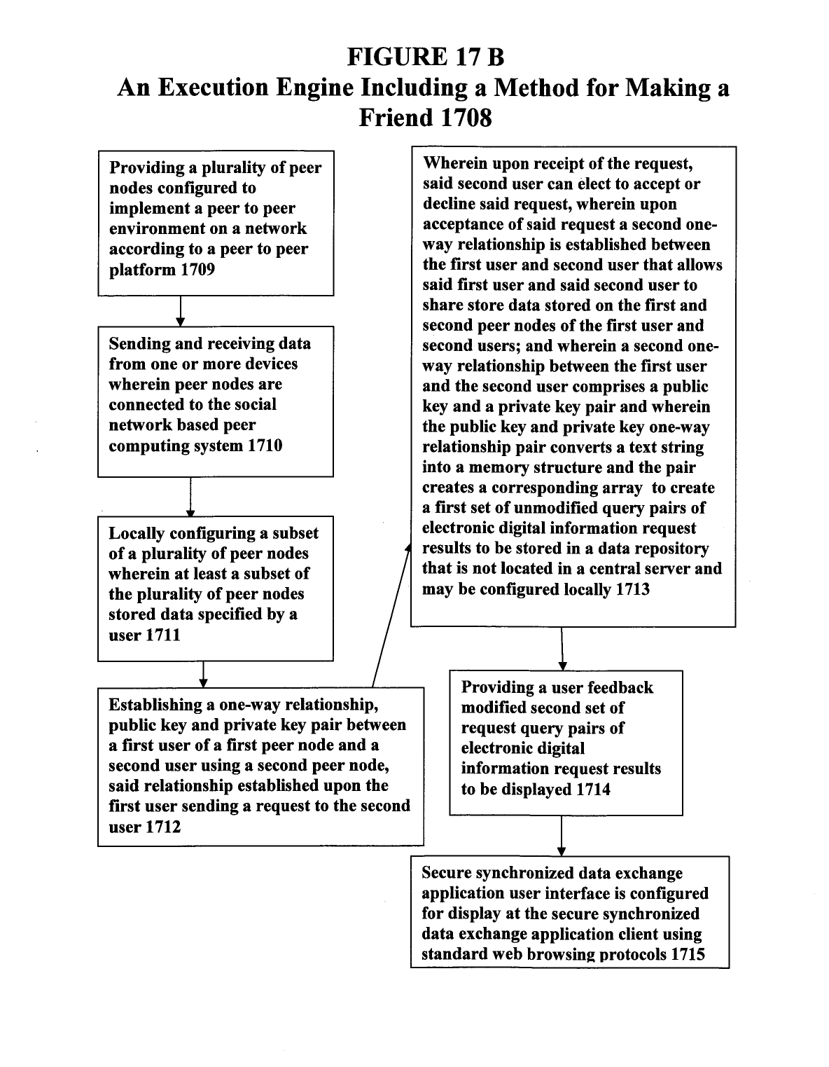

In another embodiment of FIG. 17, a customizable application system is shown.

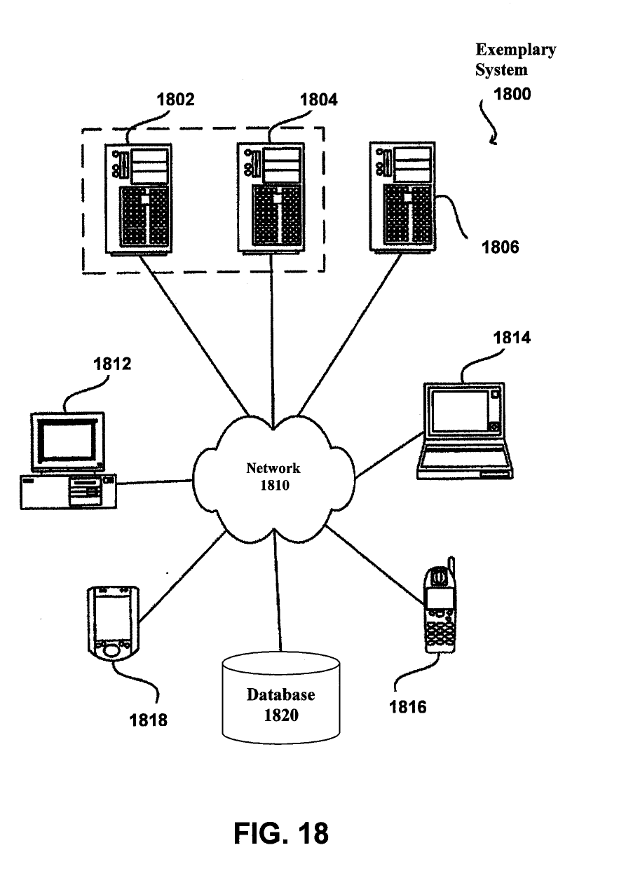

In another embodiment of FIG. 18, an exemplary operating environment including one or more user computers, computing devices, or processing devices, which can be used to operate a client, such as a dedicated application, web browser is shown.

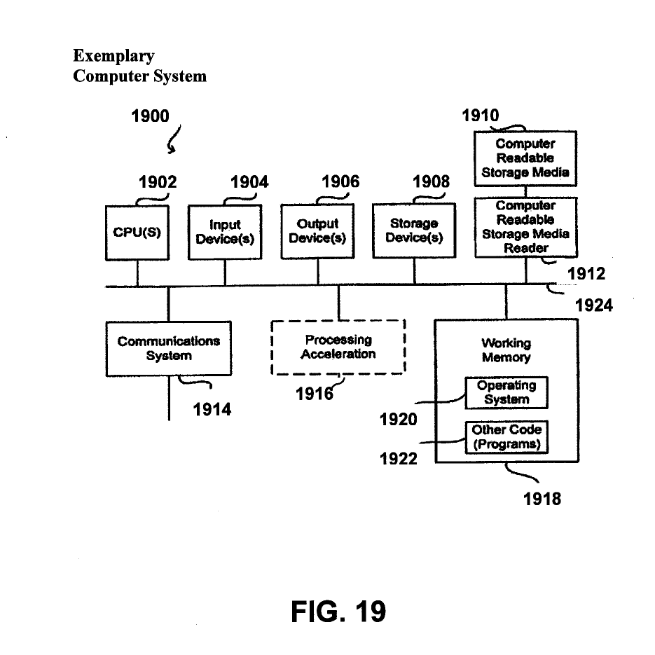

In another embodiment of FIG. 19, an exemplary operating environment, distributed peer to peer computing network is shown.

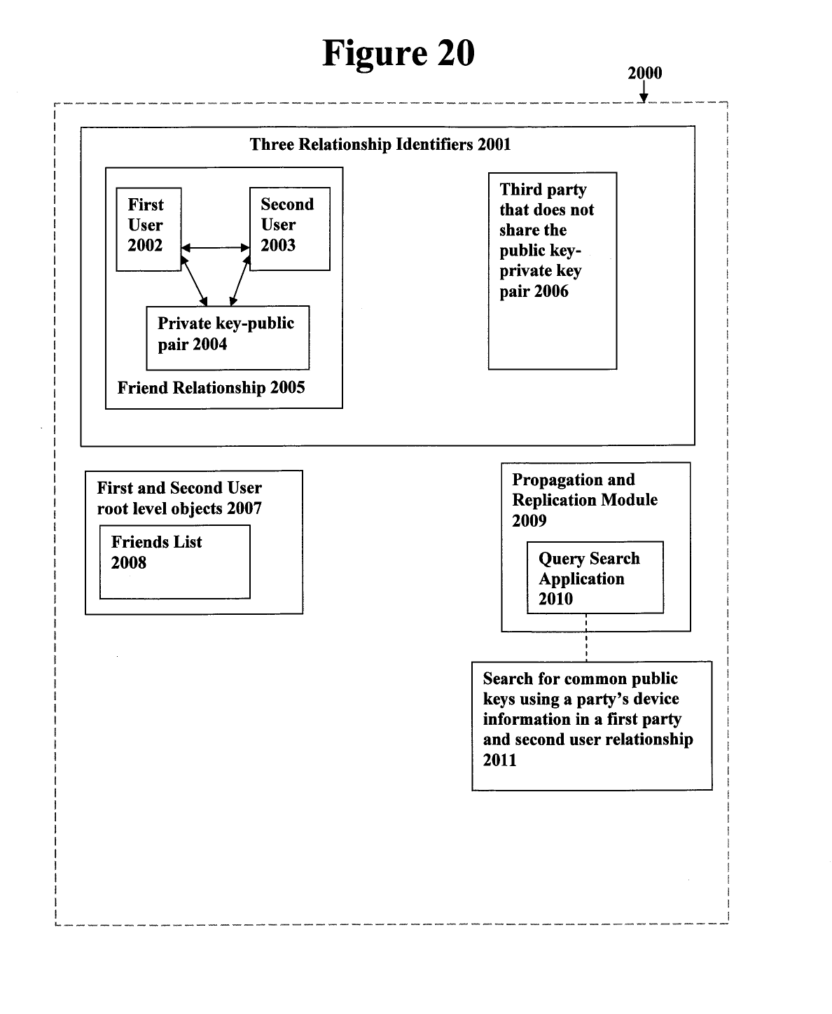

In another embodiment as shown in FIG. 20, a three party social network arrangement that comprises three relationship identifiers including a first user and a second user that share a private key-public key pair in a friend relationship is shown.

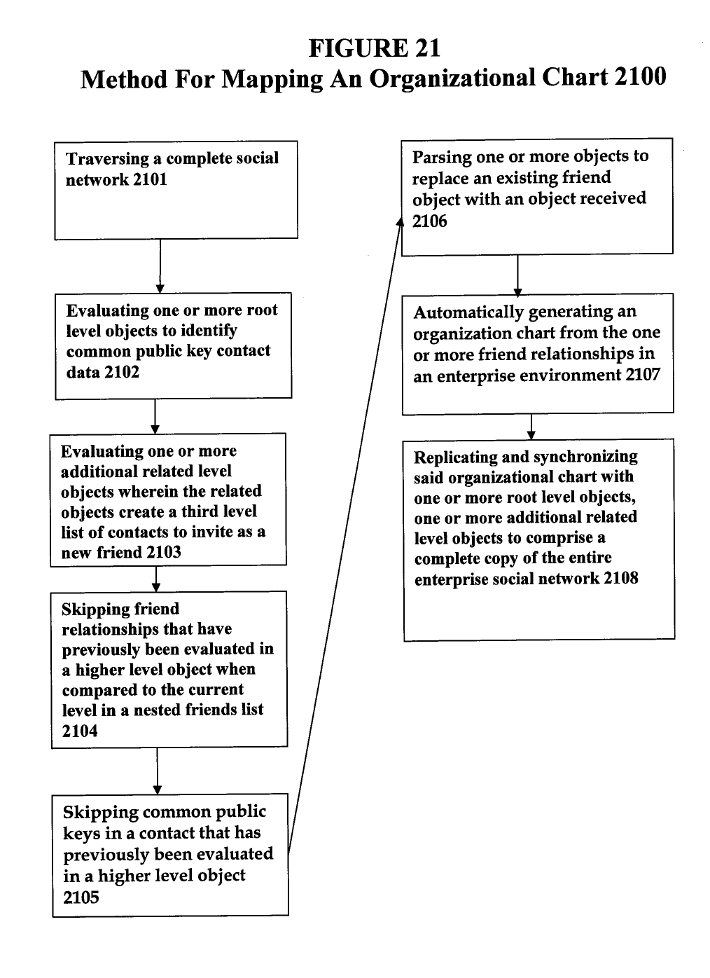

In another embodiment as shown in FIG. 21, a method for mapping an organizational chart is shown.

### DETAILED DESCRIPTION OF THE INVENTION

The present invention provides systems and methods for managing license objects to applications in an application platform. The systems and methods are particularly useful in an on-demand database service.

### Exemplary Operating Environments, Components, and Technology

FIG. 18 is a block diagram illustrating components of an exemplary operating environment in which embodiments of the present invention may be implemented. The system 1800 can include one or more user computers, computing devices, or processing devices 1812, 1814, 1816, 1818, which can be used to operate a client, such as a dedicated application, web browser, etc. The user computers 1812, 1814, 1816, 1818 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 1812, 1814, 1816, 1818 may also have any of a variety of applications, including one or more development systems, database client and/or server applications, and Web browser applications. Alternatively, the user computers 1812, 1814, 1816, 1818 may be any other electronic device, such as a thin-client computer, Internet-enabled gaming system, and/or personal messaging device, capable of communicating via a network (e.g., the network 1810 described below) and/or displaying and navigating Web pages or other types of electronic documents. Although the exemplary system 1800 is shown with four user computers, any number of user computers may be supported.

In most embodiments, the system 1800 includes some type of network 1810. The network can be any type of network familiar to those skilled in the art that can support data communications using any of a variety of commercially-available protocols, including without limitation TCP/IP, SNA, IPX, AppleTalk, and the like. Merely by way of example, the network 1810 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 1802, 1804, 1806 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 1806) may be dedicated to running applications, such as a business application, a Web server, application server, etc. Such servers may be used to process requests from user computers 1812, 1814, 1816, 1818. The applications can also include any number of applications for controlling access to resources of the servers 1802, 1804, 1806.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 1812, 1814, 1816, 1818. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 1812, 1814, 1816, 1818.

The system 1800 may also include one or more databases 1820. The database(s) 1820 may reside in a variety of locations. By way of example, a database 1820 may reside on a storage medium local to (and/or resident in) one or more of the computers 1802, 1804, 1806, 1812, 1814, 1816, 1818. Alternatively, it may be remote from any or all of the computers 1802, 1804, 1806, 1812, 1814, 1816, 1818, and/or in communication (e.g., via the network 1810) with one or more of these. In a particular set of embodiments, the database 1820 may reside in a storage-area network (“SAN”) familiar to those skilled in the art. Similarly, any necessary files for performing the functions attributed to the computers 1802, 1804, 1806, 1812, 1814, 1816, 1818 may be stored locally on the respective computer and/or remotely, as appropriate. In one set of embodiments, the database 1820 may be a relational database, such as Oracle 10g, that is adapted to store, update, and retrieve data in response to SQL-formatted commands.

FIG. 19 illustrates an exemplary computer system 1900, in which embodiments of the present invention may be implemented. The system 1900 may be used to implement any of the computer systems described above. The computer system 1900 is shown comprising hardware elements that may be electrically coupled via a bus 1924. The hardware elements may include one or more central processing units (CPUs) 1902, one or more input devices 1904 (e.g., a mouse, a keyboard, etc.), and one or more output devices 1906 (e.g., a display device, a printer, etc.). The computer system 1900 may also include one or more storage devices 1908. By way of example, the storage device(s) 1908 can include devices such as disk drives, optical storage devices, solid-state storage device such as a random access memory (“RAM”) and/or a read-only memory (“ROM”), which can be programmable, flash-updateable and/or the like.

The computer system 1900 may additionally include a computer-readable storage media reader 1912, a communications system 1914 (e.g., a modem, a network card (wireless or wired), an infra-red communication device, etc.), and working memory 1918, which may include RAM and ROM devices as described above. In some embodiments, the computer system 1900 may also include a processing acceleration unit 1916, which can include a digital signal processor DSP, a special-purpose processor, and/or the like.

The computer-readable storage media reader 1912 can further be connected to a computer-readable storage medium 1910, together (and, optionally, in combination with storage device(s) 1908) comprehensively representing remote, local, fixed, and/or removable storage devices plus storage media for temporarily and/or more permanently containing, storing, transmitting, and retrieving computer-readable information. The communications system 1914 may permit data to be exchanged with the network and/or any other computer described above with respect to the system 1900.

The computer system 1900 may also comprise software elements, shown as being currently located within a working memory 1918, including an operating system 1920 and/or other code 1922, such as an application program (which may be a client application, Web browser, mid-tier application, RDBMS, etc.). It should be appreciated that alternate embodiments of a computer system 1900 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

FIG. 19 further illustrates an environment where an on-demand distributed database service might be used. As illustrated in FIG. 19 user systems might interact via a network with an on-demand database. Some on-demand databases may store information from one or more records stored into tables of one or more distributed database images to form a database management system (DBMS). Accordingly, on-demand database and system will be used interchangeably herein. A database image may include one or more database objects. A relational database management system (RDMS) or the equivalent may execute storage and retrieval of information against the database object(s). Some on-demand database services may include an application platform that enables creation, managing and executing one or more applications developed by the provider of the on-demand database service, wherein users accesses the on-demand database service via user systems, or third party application developers access the on-demand database service via user systems.

The security of a particular user system might be entirely determined by permissions (permission levels) for the current user. For example, where a user account identification transaction may involve a portable identification alpha-numeric data field physically or digitally linked to a personal primary identification device to request services from a provider account and wherein the user is using a particular user system to interact with System, that user system has the permissions allotted to that user account. However, while an administrator is using that user system to interact with System, that user system has the permissions allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different permissions with regard to accessing and modifying application and database information, depending on a user's security or permission level.

A network can be a LAN (local area network), WAN (wide area network), wireless network, point-to-point network, star network, token ring network, hub network, or other appropriate configuration. As the most common type of network in current use is a TCP/IP (Transfer Control Protocol and Internet Protocol) network such as the global internetwork of networks often referred to as the “Internet” with a capital “I,” that will be used in many of the examples herein. However, it should be understood that the networks that the present invention might use are not so limited, although TCP/IP is a frequently implemented protocol.

User systems might communicate with a system using TCP/IP and, at a higher network level, use other common Internet protocols to communicate, such as HTTP, FTP, AFS, WAP, etc. In an example where HTTP is used, a user system might include an HTTP client commonly referred to as a “browser” for sending and receiving HTTP messages to and from an HTTP server at System. Such HTTP server might be implemented as the sole network interface between a system and network, but other techniques might be used as well or instead. In some implementations, the interface between a system and network includes load sharing functionality, such as round-robin HTTP request distributors to balance loads and distribute incoming HTTP requests evenly over a plurality of servers. At least as for the users that are accessing that server, each of the plurality of servers has access to at least one third party entity system data schema; however, other alternative configurations are contemplated.

According to one arrangement, each user system and all of its components are operator configurable using applications, such as a browser, including computer code run using a central processing unit such as an Intel Pentium® processor or the like. Similarly, a computer system (and additional instances of an enterprise database, where more than one is present) and all of their components might be operator configurable using application(s) including computer code run using a central processing unit such as an Intel Pentium® processor or the like, or multiple processor units. A computer program product aspect includes a machine-readable storage medium (media) having instructions stored thereon/in which can be used to program a computer to perform any of the processes of the embodiments described herein. Computer code for operating and configuring systems to intercommunicate and to process web pages, applications and other data and media content as described herein is preferably downloaded and stored on a hard disk, but the entire program code, or portions thereof, may also be locally stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a client system and/or server or server system such as, for example, in C, C++, HTML, any other markup language, Java™, JavaScript, ActiveX, any other scripting language such as VBScript, and many other programming languages as are well known. (Java™ is a trademark of Sun Microsystems, Inc.).

The above illustrations provide many different embodiments for implementing different features of the invention. Specific embodiments of components and processes are described to help clarify the invention. These are, of course, merely embodiments and are not intended to limit the invention from that described in the claims.

An exemplary application platform peer to peer network includes an application setup mechanism that supports application developers' creation and management of applications, which may be saved as metadata into a database by save routines for execution by subscribers as one or more processes managed by distributed database management processes for example. Invocations to such applications may be coded using PL/SOQL that provides a programming language style interface extension to an application programming interface API or other suitable programming languages. Invocations to applications may be detected by one or more system processes which manage retrieval of application metadata for the subscriber making the invocation and executing the metadata as an application in a virtual machine.

It should also be understood that each application server may be communicably coupled to one or more distributed database systems, e.g., system database and multi-enterprise database(s), via a different network connection to form a peer to peer network. For example, one server might be coupled via the Internet, another server might be coupled via a direct network link, and another server might be coupled by yet a different network connection. Transfer Control Protocol and Internet Protocol (TCP/IP) are typical protocols for communicating between servers and one or more distributed database systems. However, it will be apparent to one skilled in the art that other transport protocols may be used to optimize the system depending on the network interconnect used to implement the peer to peer, distributed network.

Each of the one or more distributed database systems can generally be viewed as a collection of objects, such as a set of logical tables, containing data fitted into predefined categories. A “table” is one representation of a data object, and is used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields.

According to one embodiment as shown in FIG. 1, a social network based peer computing system 100 comprises a plurality of peer nodes configured to implement a peer to peer environment on a network according to a peer to peer platform 110; wherein peer nodes connected to said social network based peer computing system are capable of sending and receiving data from other devices connected to the social network based peer computing system 120; wherein at least a subset of the plurality of peer nodes is locally configured to store data specified by a user 130; and wherein a first user of at least one peer node establishes a relationship with a second user using at least one peer node, said relationship established upon the first user sending a request to the second user, said request consisting of information selected from the group consisting of a file, text string, and data in a structured format 140; wherein upon receipt of the request, said second user can elect to accept or decline said request, wherein upon acceptance of said request a relationship is established between the first user and second user that allows said first user and said second user to share store data stored on the peer node of the first user and second user 150.

According to another aspect of the embodiment as shown in FIG. 1, a social network based peer computing system 100, comprises one or more of peer nodes 102 configured to implement a peer to peer environment on a network according to a peer to peer platform 110; wherein peer nodes connected to said social network based peer computing system are capable of sending and receiving data from other devices connected to the social network based peer computing system 120; wherein at least a subset of the one or more peer nodes is locally configured to store data specified by a user without the use of a central server 130; wherein a first user has one or more devices 131 connected to one or more peer nodes 102, and wherein said first user updates stored data comprising a profile 135, wherein upon updating said profile, the profile is automatically migrated and replicated to said first user's remaining devices 136 that are connected to one or more peer nodes; wherein a first user of at least one or more devices establishes a first one way relationship 137 with a second user using at least one peer node 138, said first one way relationship 137 established upon the first user directly sending a request 139 to the second user without the use of a central server, said request consisting of text string information 140 comprised of a file 141, text string identifier 142, and data 143 in a structured format 145, wherein said text string information 140 is selected from the group consisting of the first user's IP address 146, the first user's public key identifier 147, and a first user-selected message 148; wherein upon receipt of the request, said second user can elect to accept or decline said request, wherein upon response to said request a second one way relationship 149 is established; and wherein upon acceptance of said request a relationship is established between the first user and the second user that allows said first user and said second user to share stored data 145 stored on the device of the first user and peer node of the second user to create a public key, private key pair 150.

According to various aspects of the embodiment as shown in FIG. 1, the public key, private key pair 150 includes the second one way relationship 149 that comprises a private key response 151 to said request to create a trust relationship 152 by downloading a file. In various aspects, the embodiment also includes the social network based peer computing system 100 wherein the peer nodes comprise a memory for storing data 101, a processor capable of executing processor readable code 102, and a communications port for transmitting and receiving data from other peer nodes in said social network based peer computing system 103. In other aspects, the first and second one way relationships 137, 149 converts a text string into a memory structure 104 that creates an array 106 to send instructions to one or more peer nodes 107. In another configuration, the stored data comprises a structured format 108 wherein said structured format 108 is in the form of processor readable code 109. In other certain aspects, the text string information includes a first and second dynamic IP address 191, 192 and said one or more devices 131 are selected from the group consisting of a computer 132, personal digital assistant 133, smart phone 134, and mobile phone 136. In yet other configurations of the embodiment, a first user looks up a second user by looking up said second user's public key, wherein said public key is contained within a file and wherein said file comprises the second user's public key, the second user's IP address and a text string information, and upon sending of a first encrypted message 161 and a corresponding first user privacy profile 162, said second user establishes a second one way relationship 149 between said second user and said first user, in a social network based peer computing system 100, that comprises one or more of peer nodes 102 configured to implement a peer to peer environment on a network according to a peer to peer platform 110; wherein peer nodes connected to said social network based peer computing system are capable of sending and receiving data from other devices connected to the social network based peer computing system 120; wherein at least a subset of the one or more peer nodes 180 is locally configured to store data specified by a user 181 without the use of a central server 130; wherein a first user has one or more devices connected to one or more peer nodes, and wherein said first user updates stored data comprising a profile 135, wherein upon updating said profile, the profile is automatically migrated and replicated to said first user's remaining devices 136 that are connected to one or more peer nodes; wherein a first user of at least one or more devices establishes a one way relationship with a second user using at least one peer node 138, said one way relationship established upon the first user directly sending a request to the second user without the use of a central server, said request consisting of text string information comprised of a file, text string identifier, and data in a structured format 140, wherein said text string information is selected from the group consisting of the first user's IP address, the first user's public key identifier, and a first user-selected message; wherein upon receipt of the request, said second user can elect to respond and accept or decline said request, wherein upon response to said request a second one way relationship is established; and wherein upon acceptance of said request a relationship is established between the first user and the second user that allows said first user and said second user to share stored data 145 stored on the device of the first user and peer node of the second user to create a public key, private key pair 150. In yet another configuration of the embodiment of FIG. 1, a first user has at least two devices 175 connected to one or more peer nodes, wherein at least one of said two devices has established a public key/private key pair relationship 150 with a second user, wherein said second user has at least two devices 175 connected to one or more peer nodes, wherein at least one of said two devices of said second user is participating in the public key/private key pair relationship 150 with said first user, wherein upon a first user updating store data on at least one device said store data is automatically migrated and replicated to at least one device of said second user via the public key/private key pair relationship 150, wherein upon replication to at least one device of said second user 155, said one device of said second user automatically migrates and replicates said store data to remaining devices of said second user 156 connected to one or more peer nodes.

According to another embodiment as shown in FIG. 2, a two way communication is transmitted between a first user and a second user 200, wherein a first user 201 sends an unencrypted public key 203 along with an encrypted private key 204 and a corresponding object 205 to a second user 202, said encrypted private key and corresponding object locally stored on a device 210 belonging to said first user, wherein said private key and corresponding object are encrypted during transmission 212 to said second user. In certain aspects, the embodiment includes a configuration wherein a second user sends an unencrypted public key 213 along with an encrypted private key 214 and corresponding object 215 to a first user, said encrypted private key 214 and corresponding object locally stored on a device 215 belong to said second user, wherein said private key and corresponding object are encrypted during transmission to said first user.

According to an embodiment as shown in FIG. 3, a public key/private key pairing for a relationship 301 wherein a first user 305 and a second user 306 communicate by sharing the same public key/private key pair with each other 300, wherein upon sharing the same public key/private key pair 301, the first user 305 and second user 306 may send encrypted messages 307 to each other. In another aspect, one or more of the encrypted messages 307 are an object 310 comprising a user's IP address 308 and a text string 309.

According to an embodiment as shown in FIG. 4, a social network peer to peer structure 400, comprises one or more devices associated with a first user 401, the one or more devices associated with a first user each having a root level object 402, the one or more root level objects that are associated with the one or more devices associated with a first user each include a first device identified as a device 0 403, a second device identified as a device 1 404, and sequentially in the same pattern for the first user total associated devices in the peer to peer network 405, one or more root level objects 406 further comprise a device information level 407 including Internet Protocol (IP) addresses for each corresponding device other than the device 0 408 and friend information including a first friend identified as friend 0 409, a second friend identified as friend 1 410, and sequentially in the same pattern for the first user total associated devices not including the device 0 411 and the first user total associated friends not including the friend 0 412.

According to other various aspects of the embodiment as shown in FIG. 4, a social network peer to peer structure 400, comprises one or more devices associated with a first user 401, the one or more devices associated with a first user each having a root level object 402, the one or more root level objects that are associated with the one or more devices associated with a first user each include a first device identified as a device 0 403, a second device identified as a device 1 404, and sequentially in the same pattern for the first user total associated devices in the peer to peer network 405, the one or more root level objects 406 further comprises a device information level 407 including Internet Protocol (IP) addresses for each corresponding device other than the device 0 408 and friend information including a first friend identified as friend 0 409, a second friend identified as friend 1 410, and sequentially in the same pattern for the first user total associated devices not including the device 0 411 and the first user total associated friends not including the friend 0 412 and one or more device information data strings 413 including device specific information 414 corresponding to each first user device wherein the device information data string includes one or more data elements 415 selected from the group consisting of reference device IP address 416, reference device protocol version 417, and connection information 418, wherein one or more associated friends corresponding to a first user 419 and wherein said one or more associated friends 419 comprises corresponding one or more device information data strings 420.

According to other various aspects of the embodiment as shown in FIG. 4, a social network peer to peer structure, comprises one or more devices associated with a first user, the one or more devices associated with a first user each having a root level object, the one or more root level objects that are associated with the one or more devices associated with a first user each include a first device identified as a device 0, a second device identified as a device 1, and sequentially in the same pattern for the first user total associated devices in the peer to peer network, the one or more root level objects further comprises a device information level including Internet Protocol (IP) addresses for each corresponding device other than the device 0 and friend information including a first friend identified as friend 0, a second friend identified as friend 1, and sequentially in the same pattern for the first user total associated devices not including the device 0 and the first user total associated friends not including the friend 0 and one or more device information data strings including device specific information corresponding to each first user device wherein the device information data string includes one or more data elements selected from the group consisting of reference device IP address, reference device protocol version, and connection information, one or more associated friends corresponding to a first user wherein said one or more associated friends comprises corresponding one or more device information data strings wherein one or more privacy setting filters associated with the one or more device information data strings, the one or more data elements, and the one or more corresponding friends, the one or more first user devices that are synchronized to each other wherein said one or more first user devices share each data change with each other said one or more first user devices to replicate said data elements and device information.

According to other various aspects of the embodiment as shown in FIG. 4, a social network peer to peer structure, comprises one or more devices associated with a first user, the one or more devices associated with a first user each having a root level object, the one or more root level objects that are associated with the one or more devices associated with a first user each include a first device identified as a device 0, a second device identified as a device 1, and sequentially in the same pattern for the first user total associated devices in the peer to peer network, the one or more root level objects further comprises a device information level including Internet Protocol (IP) addresses for each corresponding device other than the device 0 and friend information including a first friend identified as friend 0, a second friend identified as friend 1, and sequentially in the same pattern for the first user total associated devices not including the device 0 and the first user total associated friends not including the friend 0 and one or more device information data strings including device specific information corresponding to each first user device wherein the device information data string includes one or more data elements selected from the group consisting of reference device IP address, reference device protocol version, and connection information, one or more associated friends corresponding to a first user wherein said one or more associated friends comprises corresponding one or more device information data strings wherein one or more privacy setting filters associated with the one or more device information data strings, the one or more data elements, and the one or more corresponding friends, the one or more first user devices that are synchronized to each other wherein said one or more first user devices share each data change with each other said one or more first user devices to replicate said data elements and device information and wherein a first user with a multiplicity of devices is connected to one or more peer nodes, wherein each of said multiplicity of devices has established a public key/private key pair relationship with a second user, wherein said second user has at a multiplicity of devices connected to one or more peer nodes, wherein each of said multiplicity of devices is participating in the public key/private key pair relationship with each of said multiplicity of devices of said first user, wherein upon a first user updating stored data on at least one device said stored data is automatically migrated and replicated to the remaining multiplicity of devices of said first user, and wherein upon being updated each of said multiplicity of devices of said first user automatically migrates said stored data to each multiplicity of devices of said second user wherein said store data is then replicated on each of said multiplicity of devices of said second user.

According to other various aspects of the embodiment as shown in FIG. 4, a social network peer to peer structure, comprises one or more devices associated with a first user, the one or more devices associated with a first user each having a root level object, the one or more root level objects that are associated with the one or more devices associated with a first user each include a first device identified as a device 0, a second device identified as a device 1, and sequentially in the same pattern for the first user total associated devices in the peer to peer network, the one or more root level objects further comprises a device information level including Internet Protocol (IP) addresses for each corresponding device other than the device 0 and friend information including a first friend identified as friend 0, a second friend identified as friend 1, and sequentially in the same pattern for the first user total associated devices not including the device 0 and the first user total associated friends not including the friend 0 and one or more device information data strings including device specific information corresponding to each first user device wherein the device information data string includes one or more data elements selected from the group consisting of reference device IP address, reference device protocol version, and connection information, one or more associated friends corresponding to a first user wherein said one or more associated friends comprises corresponding one or more device information data strings wherein one or more privacy setting filters associated with the one or more device information data strings, the one or more data elements, and the one or more corresponding friends, the one or more first user devices that are synchronized to each other wherein said one or more first user devices share each data change with each other said one or more first user devices to replicate said data elements and device information and wherein a first user with a multiplicity of devices is connected to one or more peer nodes, wherein each of said multiplicity of devices has established a public key/private key pair relationship with a second user, wherein said second user has at a multiplicity of devices connected to one or more peer nodes, wherein each of said multiplicity of devices is participating in the public key/private key pair relationship with each of said multiplicity of devices of said first user, wherein upon a first user updating stored data on at least one device said stored data is automatically migrated and replicated to the remaining multiplicity of devices of said first user, and wherein upon being updated each of said multiplicity of devices of said first user automatically migrates said stored data to each multiplicity of devices of said second user wherein said store data is then replicated on each of said multiplicity of devices of said second user and wherein the public key/private key pair relationship establishes a two way communication between a first user and a second user, said users each including a data string comprising a public key, private key and an object, said public keys transmitted unencrypted and said private key and object combined in an encrypted transmission but held locally.

According to other various aspects of the embodiment as shown in FIG. 4, the above social network peer to peer structure is provided wherein a packet sniffer may only access the unencrypted public key portion of said two way communication. In other various aspects the social network peer to peer structure is provided wherein a first user has established a custom privacy setting wherein said custom privacy setting enables a first user to filter what portions of said first users updated stored data are automatically migrated to friends of said first user. Another configuration of the embodiment includes the above social network peer to peer structure wherein upon receipt of said first encrypted message and said first user privacy profile, said second user establishes a second one way relationship between said second user and said first user and a corresponding second user privacy profile.

According to another embodiment as shown in FIG. 5, a method for making a friend 500 comprises the following steps: generating a new public key/private key pair object representation and adding it to a first user's friend list 501; attaching a first user's device information to a copy of the public key/private key pair object representation 502; providing said object representation to a second user friend, said object representation selected from the list comprising a text file, an email, and a user-selected format 503; providing an acceptance 504; importing said object representation by a second user friend into a custom application wherein said second user friend now has said new public key/private key pair object representation 505; and sending said object representation from a second user friend's first device to all remaining devices belonging to a second user 506.

According to another embodiment as shown in FIG. 6, a method for securely sending an object from a first user to a second user 600 comprises the following steps: formatting an object comprised of user-selected data wherein said user-selected data is selected from the group consisting of a first user's IP address, a shared private key, and a text string containing user-selected text to create a packet; encrypting said object with a shared private key 601; sending the encrypted object to a second user as a packet 602; receiving of said encrypted object by a second user 603; looking up by said second user a public key of said first user, said public corresponding to the encrypted object send to said second user by said first user 604; decrypting of said encrypted object by said second user 605; examining the decrypted user-selected data by said second user 606; and replacing preexisting data with the newly received and decrypted user selected data such that said second user has updated data in accordance with the decrypted user-selected data 607.

According to another embodiment as shown in FIG. 7, a computer implemented method including computer-usable readable storage medium having computer-readable program code embodied therein for causing a computer system to perform a method of providing a social network based peer computing system 700 includes steps for configuring a plurality of peer nodes to implement a peer to peer environment on a network according to a peer to peer platform 701; connecting peer nodes to said social network based peer computing system that are capable of sending and receiving data from other devices connected to the social network based peer computing system 702; locally configuring at least a subset of the plurality of peer nodes to store data specified by a user without the use of a central server 703; automatically migrating and replicating to a first user's remaining devices when a first user has one or more devices connected to one or more peer nodes, and wherein said first user updates and profiles are automatically migrated and replicated to said first user's remaining devices 704; establishing a one way relationship between a first user of at least one or more devices and a second user corresponding to at least one peer node, said one way relationship established upon the first user directly sending a request to the second user without the use of a central server, said request consisting of text string information, wherein said text string information is selected from the group consisting of IP address, public key identifier, and a user-selected message, wherein upon receipt of the request, said second user can elect to respond and accept or decline said request, wherein upon response to said request a second one way relationship is established 705; and establishing a relationship upon acceptance of said request between the first user and the second user that allows said first user and said second user to share stored data stored on the device of the first user and peer node of the second user to create a public key, private key pair 706.

According to another aspect of the embodiment as shown in FIG. 7, a computer implemented method including computer-usable readable storage medium having computer-readable program code embodied therein for causing a computer system to perform a method of providing a social network based peer computing system further comprises steps for providing said first and second one way relationships that convert one or more text strings into a memory structure that creates an array to send instructions to one or more peer nodes 707.

According to other aspects of the embodiment as shown in FIG. 7, a computer implemented method including computer-usable readable storage medium having computer-readable program code embodied therein for causing a computer system to perform a method of providing a social network based peer computing system further includes steps for providing said first and second one way relationships that convert one or more text strings into a memory structure that creates an array to send instructions to one or more peer nodes 708. In other various aspects of the embodiment, the computer implemented method further comprises a step for configuring at least a subset of the plurality of peer nodes wherein said at least a subset of the plurality of peer nodes are locally configured to store data specified by a user 709.

According to another embodiment as shown in FIG. 8, a computer-implemented platform including computer-usable readable storage medium having computer-readable program code embodied therein for causing a computer system to perform steps to allow a first user to establish a relationship with a second user in a social network based peer computing system 800 comprises a custom computer platform 801, a plurality of peer nodes configured to implement a peer to peer environment on a network according to a peer to peer platform 802; wherein peer nodes connected to said social network based peer computing system are capable of sending and receiving data from other devices connected to the social network based peer computing system 803; wherein at least a subset of the plurality of peer nodes is locally configured to store data specified by a user 804; and wherein a first user of a first peer node establishes a relationship with a second user using a second peer node 805, said relationship established upon the first user sending a request to the second user 806; wherein upon receipt of the request, said second user can elect to respond and accept or decline said request, wherein upon acceptance of said request a relationship is established between the first user and second user that allows said first user and said second user to share store data stored on the first and second peer nodes of the first user and second users 807; and wherein a one-way relationship between the first user and the second user comprises a public key and a private key pair and wherein the public key and private key one-way relationship pair converts a text string into a memory structure 808 and the pair creates a corresponding array 809.

According to another embodiment as shown in FIG. 9, a computer-implemented method for providing a social network based peer computing system 900, comprises providing a plurality of peer nodes configured to implement a peer to peer environment on a network according to a peer to peer platform 901; sending and receiving data from one or more devices wherein peer nodes are connected to the social network based peer computing system 902; locally configuring a subset of a plurality of peer nodes wherein at least a subset of the plurality of peer nodes stored data specified by a user 903; and establishing a one-way relationship, public key and private key pair between a first user of a first peer node and a second user using a second peer node, said relationship established upon the first user sending a request to the second user wherein upon receipt of the request, said second user can elect to respond and accept or decline said request, wherein upon acceptance of said request a second one-way relationship is established between the first user and second user that allows said first user and said second user to share store data stored on the first and second peer nodes of the first user and second users 904; and wherein a second one-way relationship between the first user and the second user comprises a public key and a private key pair and wherein the public key and private key one-way relationship pair converts a text string into a memory structure and the pair creates a corresponding array to create a first set of unmodified query pairs of electronic digital information request results to be stored in a data repository that is not located in a central server and may be configured locally 905; and providing a user feedback modified second set of request query pairs of electronic digital information request results to be displayed 906.

According to another embodiment as shown in FIG. 10, a computer system for providing a social network based peer computing system, based on a first user's request secure query pair and decrypted system settings in a heterogeneous enterprise search environment 1000, comprises a computer 1001 that is coupled to a digital telecommunications network 1002 by a digital telecommunications link 1003 to form a network of said computers 1004; an electronic digital memory in the computer 1005; one or more sequences of computer program instructions stored in the electronic digital memory 1006 which, when executed, cause the computer to perform the steps of providing a first set of unmodified document query pairs of electronic digital information search results to be stored in a data repository 1007; providing a user feedback modified second set of document query pairs of electronic digital information search results to be displayed 1008; creating a social networking secure peer to peer array algorithm as a combination function comprising a plurality of step functions, said step functions specified by different user feature sets of sub-query user personalized preferences 1009; and replicating the first user's query pair and decrypted system settings in a heterogeneous enterprise peer to peer network environment with one or more associated devices to create one public/private key pair, one or more devices corresponding to one or more persons and a plurality of attempted connections 1010.

According to another aspect of the embodiment as shown in FIG. 10, the computer system for providing a social network based peer computing system, based on a first user's request secure query pair and decrypted system settings in a heterogeneous enterprise search environment, further comprises a system in which the first user 1011 and an associated second user 1012 in a friend relationship 1013p with a payment system 1014, allows both users sets of one or more devices 1015 to trade transaction data 1016; said transaction data 1016 comprising a payment amount 1017, transaction identifier 1018, and corresponding bank account information 1019 necessary for completing an e-commerce online, encrypted transaction 1020. In other various aspects, the embodiment further comprises merchant banking information 1021 to a purchaser 1022 wherein the merchant and purchaser are in a public key/private key, friend relationship 1023; merchant banking data 1021 from the purchaser's one or more synchronized devices 1024 to the purchaser's bank 1025; a deposit 1026 into the merchant's associated friend transaction bank account 1027, using the associated e-commerce friend transaction data 1028; a transaction identifier string of characters randomly generated by the merchant device 1029; an associated transaction description and other text containing fields placed to be immediately accessible by the merchant device 1030 to provide a verification that a deposit has been made for the current friend transaction 1031; and a verification of the transaction utilizing the corresponding transaction identifier and purchase amount to determine that the transaction is complete 1032.

According to another aspect of the embodiment as shown in FIG. 10, the computer system for providing a social network based peer computing system, based on a first user's request secure query pair and decrypted system settings in a heterogeneous enterprise search environment, further comprises user selected electronic digital information query results 1033 to be displayed 1034; and one or more social network based peer computing system algorithms 1035 as combination functions 1036 that comprise one or more security factors 1037, said security factors 1037 specified by different user selected weighting values 1038 corresponding to a plurality of user personalized preferences 1039 and one or more privacy profiles 1040, said privacy profiles 1040 specified by various user selected weighting values 1038 corresponding to one or more privacy profiles 1040.

According to another embodiment as shown in FIG. 11, a computer-implemented method for providing a social network based peer computing system algorithms based on customer's settings in a heterogeneous enterprise peer to peer network environment system 1100, the method comprises providing user selected electronic digital information search results to be displayed 1101; creating a social network based peer computing system algorithm as a combination function comprising a plurality of security factors, said security factors specified by different user selected weights corresponding to a plurality of user personalized preferences 1102; defining said security factors to indicate user defined document attributes and user defined preference weighting values 1103; first classifying a first grouping of security factors in a subset known to the search system 1104; first classifying a second grouping of security factors in a subset unknown to the search system, wherein said first and second grouping of security factors determine whether said security factor is known to the search system 1105; second classifying a first grouping of security factors in a subset that corresponds to whether said social network based peer computing system is dependent on said query 1106; creating a social networking secure peer to peer array algorithm as a combination function comprising a plurality of step functions, said step functions specified by different user feature sets of sub-query user personalized preferences 1107; replicating the first user's query pair and decrypted system settings in a heterogeneous enterprise search environment with one or more associated devices to create one public/private key pair, one or more devices corresponding to one or more persons and a plurality of attempted connections 1112; providing merchant banking information to a purchaser wherein the merchant and purchaser are in a public key/private key, friend relationship 1108; sending merchant banking data from the purchaser's one or more synchronized devices to the purchaser's bank 1109; making a deposit into the merchant's associated friend transaction bank account, using the associated e-commerce friend transaction data; randomly generating a transaction identifier string of characters by the merchant device 1110; associating an transaction description and other text containing fields placed to be immediately accessible by the merchant device to verify that a deposit has been made for the current friend transaction; and verifying of the transaction utilizing the corresponding transaction identifier and purchase amount to determine that the transaction is complete 1111.

According to another embodiment as shown in FIG. 12, a system for providing a social network based peer computing system modeling in an object-oriented software environment 1200, comprises a custom computer platform 1201, a plurality of peer nodes configured to implement a peer to peer environment on a network according to a peer to peer platform 1202; wherein peer nodes connected to said social network based peer computing system are capable of sending and receiving data from other devices connected to the social network based peer computing system 1203; wherein at least a subset of the plurality of peer nodes is locally configured to store data specified by a user 1204; and wherein a first user of a first peer node establishes a relationship with a second user using a second peer node, said relationship established upon the first user sending a request to the second user 1205; wherein upon receipt of the request, said second user can elect to respond and accept or decline said request, wherein upon acceptance of said request a relationship is established between the first user and second user that allows said first user and said second user to share store data stored on the first and second peer nodes of the first user and second users 1206; and wherein a one-way relationship between the first user and the second user comprises a public key and a private key pair and wherein the public key and private key one-way relationship pair converts a text string into a memory structure and the pair creates a corresponding array one or more devices associated with a first user 1207; the one or more devices associated with a first user each having a root level object, the one or more root level objects that are associated with the one or more devices associated with a first user each include a first device identified as a device 0, a second device identified as a device 1, and sequentially in the same pattern for the first user total associated devices in the peer to peer network 1208; the one or more root level objects further comprising a device information level including Internet Protocol (IP) addresses for each corresponding device other than the device 0 and friend information including a first friend identified as friend 0, a second friend identified as friend 1, and sequentially in the same pattern for the first user total associated devices not including the device 0 and the first user total associated friends not including the friend 0 1209; one or more device information data strings including device specific information corresponding to each first user device wherein the device information data string includes one or more data elements selected from the group consisting of reference device IP address, reference device protocol version, and connection information 1210; one or more associated friends corresponding to a first user wherein said one or more associated friends comprises corresponding one or more device information data strings 1211; wherein a first user with a multiplicity of devices is connected to one or more peer nodes 1212, wherein each of said multiplicity of devices has established a public key/private key pair relationship with a second user 1213, wherein said second user has at a multiplicity of devices connected to one or more peer nodes 1214, wherein each of said multiplicity of devices is participating in the public key/private key pair relationship with each of said multiplicity of devices of said first user 1215, wherein upon a first user updating stored data on at least one device said stored data is automatically migrated and replicated to the remaining multiplicity of devices of said first user 1216, and wherein upon being updated each of said multiplicity of devices of said first user automatically migrates said stored data to each multiplicity of devices of said second user wherein said store data is then replicated on each of said multiplicity of devices of said second user 1217, a processor operable to execute instructions contained in computer program code, at least one computer readable medium including steps for implementing a social network based peer computing system, a computer program code providing programming language that is general purpose and object oriented, and said computer program code for executing the mathematical algorithm represented using the programming language and solving the mathematical expressions 1218.

According to another embodiment as shown in FIG. 13, a computer readable medium for a social network peer to peer structure 1300, comprises (a) program code for sending a public key unencrypted 1301; (b) program code for holding locally a private key and object to be encrypted during transmission 1302; (c) program code for associating a first user with a second user wherein said first user has one or more corresponding devices and said second user has one or more corresponding devices 1303; (d) program code for associating device information for each user and corresponding devices of said user 1304; (e) program code for including one or more data elements to a corresponding device information data string 1305; (f) program code for generating a new public key/private key pair object representation and adding it to a first user's friend list 1306; (g) program code for attaching a first user's device information to a copy of the public key/private key pair object representation 1307; (h) program code for providing said object representation to a second user friend, said object representation selected from the list comprising a text file, an email, and a user-selected format 1308; (i) program code for providing an acceptance 1309; (j) program code for importing said object representation by a second user friend into a custom application wherein said second user friend now has said new public key/private key pair object representation 1310; and (k) program code for sending said object representation from a second user friend's first device to all remaining devices belonging to a second user 1311.

According to another embodiment as shown in FIG. 14, a secure system for record synchronization of independent databases in an application platform peer to peer computer system 1400, comprises a properly formatted file of secure alternative identifiers in a special table 1401 associated with a properly formatted file of friend requests 1402 that is performed in batch by an MARKUP LANGUAGE web service 1403, a first user and an associated second user in a friend relationship with a payment system 1404, allowing both users sets of one or more devices to trade transaction data 1405, transaction data comprising a payment amount, transaction identifier, and corresponding bank account information necessary for completing an e-commerce online, encrypted transaction 1406, and merchant banking information to a purchaser 1407 wherein the merchant and purchaser are in a public key/private key, friend relationship 1408; merchant banking data from the purchaser's one or more synchronized devices to the purchaser's bank 1409; a deposit into the merchant's associated friend transaction bank account, using the associated e-commerce friend transaction data 1410; a transaction identifier string of characters randomly generated by the merchant device 1411; an associated transaction description and other text containing fields placed to be immediately accessible by the merchant device to verify that a deposit has been made for the current friend transaction 1412; and a verification of the transaction utilizing the corresponding transaction identifier and purchase amount to determine that the transaction is complete 1413.

According to another embodiment as shown in FIG. 15, one or more processor readable storage devices having processor readable code embodied on at least one processor readable storage device, said processor readable code for programming at least one processor to perform a method of making a friend 1500 comprises generating a new public key/private key pair object representation and adding it to a first user's friend list 1501; attaching a first user's device information to a copy of the public key/private key pair object representation 1502; providing said object representation to a second user friend, said object representation selected from the list comprising a text file, an email, and a user-selected format; providing an acceptance 1503; importing said object representation by a second user friend into a custom application wherein said second user friend now has said new public key/private key pair object representation; and sending said object representation from a second user friend's first device to all remaining devices belonging to a second user providing a menu to a user in a machine readable markup language 1504; receiving one or more requests from the user for one or more encryption protected personal identifiers related to said user's one or more privacy filter data personal identifiers 1505; fetching said one or more encryption protected personal identifiers related to said user's one or more privacy filter data identifiers from a database 1506; formatting the one or more encryption protected personal identifiers related to said user's one or more privacy filter data identifiers into markup language 1507; and transmitting the markup language to the user wherein the one or more encryption protected personal identifiers related to said user's one or more privacy filter data identifiers comprises one or more aggregated database objects including one or more encryption protected personal identifiers related to said user's one or more privacy filter data identifiers, one or more third party augmented payment system database object tables, and at least one lockout security module wherein said at least one lockout security module is associated with at least one third party augmented payment system table 1508.

According to another embodiment as shown in FIG. 16, a computer-implemented apparatus for providing a method of making a friend 1600, said apparatus comprises a processor 1601; an input device coupled to said processor 1602; a memory coupled to said processor 1603; an output device 1604; and an execution engine 1605 including a method for providing method of making a friend comprising the following steps: providing a plurality of peer nodes configured to implement a peer to peer environment on a network according to a peer to peer platform 1606; sending and receiving data from one or more devices wherein peer nodes are connected to the social network based peer computing system 1607; locally configuring a subset of a plurality of peer nodes wherein at least a subset of the plurality of peer nodes stored data specified by a user 1608; and establishing a one-way relationship, public key and private key pair between a first user of a first peer node and a second user using a second peer node, said relationship established upon the first user sending a request to the second user wherein upon receipt of the request, said second user can elect to accept or decline said request, wherein upon acceptance of said request a second one-way relationship is established between the first user and second user that allows said first user and said second user to share store data stored on the first and second peer nodes of the first user and second users 1609; and wherein a second one-way relationship between the first user and the second user comprises a public key and a private key pair and wherein the public key and private key one-way relationship pair converts a text string into a memory structure and the pair creates a corresponding array to create a first set of unmodified query pairs of electronic digital information request results to be stored in a data repository that is not located in a central server and may be configured locally; and providing a user feedback modified second set of request query pairs of electronic digital information request results to be displayed 1610.

According to another embodiment as shown in FIG. 17, a customizable application system 1700 comprises a secure peer to peer computer system application execution system for public key/private key social network and payment system 1701 configured to support preventing the submittal of the private key identifier to retrieve the properly formatted and encrypted locally held personal identifier to create a private key/public key pair, friend relationship 1702; a user interface generator operable to generate a secure synchronized data exchange application user interface including a secure data exchange interface element, the secure synchronized data exchange application user interface being configured for delivery to the user over a peer to peer computer network, the secure synchronized data exchange application element including a retrieve secure privacy filter identifier command 1703; metadata characterizing the one or more augmented friend relationship identifier table objects to create the one or more properly formatted personal identifier commands 1704, wherein the user interface is operable to display an amount of data in response to a previously executed query; a processor 1716r; an input device coupled to said processor 1705; a memory coupled to said processor 1706; an output device 1707; and an execution engine 1708 including a method for providing a method of making a friend comprising the following steps: providing a plurality of peer nodes configured to implement a peer to peer environment on a network according to a peer to peer platform 1709; sending and receiving data from one or more devices wherein peer nodes are connected to the social network based peer computing system 1710; locally configuring a subset of a plurality of peer nodes wherein at least a subset of the plurality of peer nodes stored data specified by a user 1711; and establishing a one-way relationship, public key and private key pair between a first user of a first peer node and a second user using a second peer node, said relationship established upon the first user sending a request to the second user 1712 wherein upon receipt of the request, said second user can elect to accept or decline said request, wherein upon acceptance of said request a second one-way relationship is established between the first user and second user that allows said first user and said second user to share store data stored on the first and second peer nodes of the first user and second users; and wherein a second one-way relationship between the first user and the second user comprises a public key and a private key pair and wherein the public key and private key one-way relationship pair converts a text string into a memory structure and the pair creates a corresponding array to create a first set of unmodified query pairs of electronic digital information request results to be stored in a data repository that is not located in a central server and may be configured locally 1713; and providing a user feedback modified second set of request query pairs of electronic digital information request results to be displayed 1714. In other various aspects, the embodiment further comprises the customizable application system wherein the secure synchronized data exchange application user interface is configured for display at the secure synchronized data exchange application client using standard web browsing protocols 1715.

According to another embodiment as shown in FIG. 20, a computer-implemented apparatus for providing a method of providing a three party relationship in a peer to peer social network 2000, said apparatus comprises a processor 2001; an input device coupled to said processor 2002; a memory coupled to said processor 2003; an output device 2004; and an execution engine 2005 including a method for providing a three party relationship in a peer to peer social network comprises the following steps: providing a plurality of peer nodes configured to implement a three party relationship in a peer to peer environment on a network comprising three peer to peer relationship identifiers wherein said relationship identifiers represent a one to one pairing between two of the three parties 2006; providing three one to one relationship identifiers wherein each said one to one relationship identifier is unknown to an uncommon third party 2021; sending and receiving data from one or more devices wherein peer nodes are connected to the social network based peer computing system 2007; locally configuring a subset of a plurality of peer nodes wherein at least a subset of the plurality of peer nodes stored data specified by a user 2008; and establishing a one-way relationship, public key and private key pair between a first user of a first peer node and a second user using a second peer node, said relationship established upon the first user sending a request to the second user wherein upon receipt of the request, said second user can elect to accept or decline said request, wherein upon acceptance of said request a second one-way relationship is established between the first user and second user that allows said first user and said second user to share store data stored on the first and second peer nodes of the first user and second users 2009; and wherein a second one-way relationship between the first user and the second user comprises a public key and a private key pair relationship identifier unknown to the third party in a three party relationship and wherein the public key and private key one-way relationship pair converts a text string into a memory structure and the pair creates a corresponding array to create a first set of unmodified query pairs of electronic digital information request results to be stored in a data repository that is not located in a central server and may be configured locally 2011; and providing a user feedback modified second set of request query pairs of electronic digital information request results to be displayed 2010.

While the invention has been described by way of example and in terms of the specific embodiments, it is to be understood that the invention is not limited to the disclosed embodiments and may alternatively be applied to closed system, heterogeneous enterprise network environments, intranets, or other secure, closed organizational arrangements.

According to another embodiment as shown in FIG. 20, a three party social network arrangement 2000 comprises three relationship identifiers 2001 including a first user 2002 and a second user 2003 that share a private key-public key pair 2004 in a friend relationship 2005 and relate generally to a third party that does not share the public key-private key pair 2006 and is therefore not known to the first and second user and wherein the first and second user root level objects 2007 include a friends list 2008 and wherein a propagation and replication module 2009 of the three party social network arrangement comprises a query search application 2010 to search for common public keys using a party's device information in a first party and second user relationship 2011. In other aspects the embodiment may variously include a single instance of a query of device information data from one or more root level objects 2012 and associated nested friends lists in additional related level objects 2013 wherein the related objects create a third level list of contacts to invite as a new friend 2014, one of the three relationship identifiers wherein a third party is unknown to the first and second user in the absence of a common public key 2015 and wherein a third party may not access or identify an individual in the social network 2016, the three party social network arrangement 2000 wherein each user has no link to a central database, server, and no account thereon 2017 and wherein each device in the social network contains a complete copy of the entire social network including its my device object data 2018, a three party social network arrangement wherein a friend or employee will have complete, real time contact information for every other friend or employee in the closed environment 2019, and a three party social network arrangement wherein an organization chart is automatically generated and a complete suite of possible document, media, sharing and messaging is available in a fully implemented, private, secure, social network in the closed, enterprise environment 2020.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

In another embodiment as shown in FIG. 21, a method for mapping an organizational chart 2100 comprises traversing a complete social network 2101; evaluating one or more root level objects to identify common public key contact data 2102; evaluating one or more additional related level objects wherein the related objects create a third level list of contacts to invite as a new friend 2103; skipping friend relationships that have previously been evaluated in a higher level object when compared to the current level in a nested friends list 2104; skipping common public keys in a contact that has previously been evaluated in a higher level object 2105; parsing one or more objects to replace an existing friend object with an object received 2106; automatically generating an organization chart from the one or more friend relationships in an enterprise environment 2107; and replicating and synchronizing said organizational chart with one or more root level objects, one or more additional related level objects to comprise a complete copy of the entire enterprise social network 2108.

What is claimed is:

1. A social network based peer computing system, comprising:
one or more of peer nodes configured to implement a peer to peer environment on a network according to a peer to peer platform;
wherein peer nodes connected to said social network based peer computing system are capable of sending and receiving data from other devices connected to the social network based peer computing system;
wherein at least a subset of the plurality of peer nodes is locally configured to store data specified by a user without the use of a central server;
wherein a first user has one or more devices connected to one or more peer nodes, and wherein said first user updates stored data comprising a profile, wherein upon updating said profile the profile is automatically migrated and replicated to said first user's remaining devices that are connected to one or more peer nodes.
wherein a first user of at least one or more devices establishes a one way relationship with a second user using at least one peer node, said one way relationship established upon the first user directly sending a request to the second user without the use of a central server, said request consisting of text string information, wherein said text string information is selected from the group consisting of the first user's IP address, the first user's public key identifier, and a first user-selected message.
wherein upon receipt of the request, said second user can elect to accept or decline said request, wherein upon response to said request a second one way relationship is established; and
wherein upon acceptance of said request a relationship is established between the first user and the second user that allows said first user and said second user to share stored data stored on the device of the first user and peer node of the second user to create a public key, private key pair.

2. The social network based peer computing system of claim 1, wherein said public key, private key pair includes said second one way relationship comprising a private key response to said request to create a trust relationship by downloading a file.

3. The social network based peer computing system of claim 1 wherein said peer nodes comprise a memory for storing data, a processor capable of executing processor readable code, and a communications port for transmitting and receiving data from other peer nodes in said social network based peer computing system.

4. The social network based peer computing system of claim 1 wherein said first and second one way relationships converts a text string into a memory structure that creates an array to send instructions to one or more peer nodes.

5. The social network based peer computing system of claim 4 wherein the stored data comprises a structured format wherein said structured format is in the form of processor readable code.

6. The social network based peer computing system of claim 2 wherein said text string information includes a first and second dynamic IP address.

7. The social network based peer computing system of claim 1 wherein said one or more devices are selected from the group consisting of a computer, personal digital assistant, smart phone, and mobile phone.

8. The social network based peer computing system of claim 2 wherein a first user looks up a second user by looking up said second user's public key

9. The social network based peer computing system of claim 8 wherein said public key is contained within a file and wherein said file consists of the second user's public key, the second user's IP address and a text string information.

10. The social network based peer computing system of claim 8 wherein said public key is contained within an object and wherein said object consists of the second user's public key, the second user's IP address and an information text string data element.

11. The social network based peer computing system of claim 8 wherein upon sending of a first encrypted message and a corresponding first user privacy profile, said second user establishes a second one way relationship between said second user and said first user.

12. A two way communication between a first user and a second user, wherein a first user sends an unencrypted public key along with an encrypted private key and corresponding object to a second user, said encrypted private key and corresponding object locally stored on a device belong to said first user, wherein said private key and corresponding object are encrypted during transmission to said second user.

13. The two way communication between a second user and a first user of claim 12, wherein a second user sends an unencrypted public key along with an encrypted private key and corresponding object to a first user, said encrypted private key and corresponding object locally stored on a device belong to said second user, wherein said private key and corresponding object are encrypted during transmission to said first user.

14. A public key/private key pairing for a relationship wherein a first user and a second user communicate by sharing the same public key/private key pair with each other, wherein upon sharing the same public key/private key pair, the first user and second use may send encrypted messages to each other.

15. The public key/private key pairing for a relationship of claim 14, wherein the encrypted message is an object consisting of a user's IP address and a text string.

16. The social network based peer computing system of claim 11 wherein a first user has at least two devices connected to one or more peer nodes, wherein at least one of said two devices has established a public key/private key pair relationship with a second user, wherein said second user has at least two devices connected to one or more peer nodes, wherein at least one of said two devices of said second user is participating in the public key/private key pair relationship with said first user, wherein upon a first user updating store data on at least one device said store data is automatically migrated and replicated to at least one device of said second user via the public key/private key pair relationship, wherein upon replication to at least one device of said second user, said one device of said second user automatically migrates and replicates said store data to remaining devices of said second user connected to one or more peer nodes.

17. A social network peer to peer structure, comprising:
one or more devices associated with a first user,
the one or more devices associated with a first user each having a root level object,
the one or more root level objects that are associated with the one or more devices associated with a first user each include a first device identified as a device 0, a second device identified as a device 1, and sequentially in the same pattern for the first user total associated devices in the peer to peer network,
the one or more root level objects further comprising a device information level including Internet Protocol (IP) addresses for each corresponding device other than the device 0 and friend information including a first friend identified as friend 0, a second friend identified as friend 1, and sequentially in the same pattern for the first user total associated devices not including the device 0 and the first user total associated friends not including the friend 0.

18. The social network peer to peer structure of claim 17, further comprising:
one or more device information data strings including device specific information corresponding to each first user device wherein the device information data string includes one or more data elements selected from the group consisting of reference device IP address, reference device protocol version, and connection information,
one or more associated friends corresponding to a first user wherein said one or more associated friends comprises corresponding one or more device information data strings.

19. The social network peer to peer structure of claim 18, further comprising:
one or more privacy setting filters associated with the one or more device information data strings, the one or more data elements, and the one or more corresponding friends,
the one or more first user devices that are synchronized to each other wherein said one or more first user devices share each data change with each other said one or more first user devices to replicate said data elements and device information.

20. The social network based peer to peer structure of claim 19 wherein a first user with a multiplicity of devices is connected to one or more peer nodes, wherein each of said multiplicity of devices has established a public key/private key pair relationship with a second user, wherein said second user has at a multiplicity of devices connected to one or more peer nodes, wherein each of said multiplicity of devices is participating in the public key/private key pair relationship with each of said multiplicity of devices of said first user, wherein upon a first user updating stored data on at least one device said stored data is automatically migrated and replicated to the remaining multiplicity of devices of said first user, and wherein upon being updated each of said multiplicity of devices of said first user automatically migrates said stored data to each multiplicity of devices of said second user wherein said store data is then replicated on each of said multiplicity of devices of said second user.

21. The social network peer to peer structure of claim 20 wherein the public key/private key pair relationship establishes a two way communication between a first user and a second user, said users each including a data string comprising a public key, private key and an object, said public keys transmitted unencrypted and said private key and object combined in an encrypted transmission but held locally.

22. The social network peer to peer structure of claim 21 wherein a packet sniffer may only access the unencrypted public key portion of said two way communication.

23. The social network peer to peer structure of claim 20 wherein a first user has established a custom privacy setting wherein said custom privacy setting enables a first user to filter what portions of said first users updated stored data are automatically migrated to friends of said first user.

24. A method for making a friend comprising the following steps:
generating a new public key/private key pair object representation and adding it to a first user's friend list;
attaching a first user's device information to a copy of the public key/private key pair object representation;
providing said object representation to a second user friend, said object representation selected from the list comprising a text file, an email, and a user-selected format;
providing an acceptance;
importing said object representation by a second user friend into a custom application wherein said second user friend now has said new public key/private key pair object representation; and
sending said object representation from a second user friend's first device to all remaining devices belonging to a second user.

25. A method for securely sending an object from a first user to a second user comprising the following steps:
formatting an object comprised of user-selected data wherein said user-selected data is selected from the group consisting of a first user's IP address, a shared private key, and a text string containing user-selected text to create a packet;
encrypting said object with a shared private key;
sending the encrypted object to a second user as a packet;
receiving of said encrypted object by a second user;
looking up by said second user a public key of said first user, said public corresponding to the encrypted object send to said second user by said first user;
decrypting of said encrypted object by said second user;
examining the decrypted user-selected data by said second user; and
replacing preexisting data with the newly received and decrypted user selected data such that said second user has updated data in accordance with the decrypted user-selected data.

26. The social network based peer computing system of claim 16 wherein upon receipt of said first encrypted message and said first user privacy profile, said second user establishes a second one way relationship between said second user and said first user and a corresponding second user privacy profile.

27. A computer implemented method including computer-usable readable storage medium having computer-readable program code embodied therein for causing a computer system to perform a method of providing a social network based peer computing system:
configuring a plurality of peer nodes to implement a peer to peer environment on a network according to a peer to peer platform;
connecting peer nodes to said social network based peer computing system that are capable of sending and receiving data from other devices connected to the social network based peer computing system;
locally configuring at least a subset of the plurality of peer nodes to store data specified by a user without the use of a central server;
automatically migrating and replicating to a first user's remaining devices when a first user has one or more devices connected to one or more peer nodes, and wherein said first user updates and profiles are automatically migrated and replicated to said first user's remaining devices;
establishing a one way relationship between a first user of at least one or more devices and a second user corresponding to at least one peer node, said one way relationship established upon the first user directly sending a request to the second user without the use of a central server, said request consisting of text string information, wherein said text string information is selected from the group consisting of IP address, public key identifier, and a user-selected message, wherein upon receipt of the request, said second user can elect to accept or decline said request, wherein upon response to said request a second one way relationship is established; and
establishing a relationship upon acceptance of said request between the first user and the second user that allows said first user and said second user to share stored data stored on the device of the first user and peer node of the second user to create a public key, private key pair.

28. The computer implemented method of claim 27 including computer usable readable storage medium having computer-readable program code embodied therein for causing a computer system to perform a method of providing a social network based peer computing system, further comprising:
providing said first and second one way relationships that convert one or more text strings into a memory structure that creates an array to send instructions to one or more peer nodes.

29. The computer implemented method of claim 27 including computer-usable readable storage medium having computer-readable program code embodied therein for causing a computer system to perform a method of providing a social network based peer computing system, further comprising:
configuring at least a subset of the plurality of peer nodes wherein said at least a subset of the plurality of peer nodes are locally configured to store data specified by a user.

30. A computer-implemented platform including computer-usable readable storage medium having computer-readable program code embodied therein for causing a computer system to perform steps to allow a first user to establish a relationship with a second user in a social network based peer computing system comprising:
a custom computer platform,
a plurality of peer nodes configured to implement a peer to peer environment on a network according to a peer to peer platform; wherein peer nodes connected to said social network based peer computing system are capable of sending and receiving data from other devices connected to the social network based peer computing system;
wherein at least a subset of the plurality of peer nodes is locally configured to store data specified by a user; and
wherein a first user of a first peer node establishes a relationship with a second user using a second peer node, said relationship established upon the first user sending a request to the second user;
wherein upon receipt of the request, said second user can elect to accept or decline said request, wherein upon acceptance of said request a relationship is established between the first user and second user that allows said first user and said second user to share store data stored on the first and second peer nodes of the first user and second users; and
wherein a one-way relationship between the first user and the second user comprises a public key and a private key pair and wherein the public key and private key one-way relationship pair converts a text string into a memory structure and the pair creates a corresponding array

31. A computer-implemented method for providing a social network based peer computing system, the method comprising:
providing a plurality of peer nodes configured to implement a peer to peer environment on a network according to a peer to peer platform;
sending and receiving data from one or more devices wherein peer nodes are connected to the social network based peer computing system;
locally configuring a subset of a plurality of peer nodes wherein at least a subset of the plurality of peer nodes stored data specified by a user; and
establishing a one-way relationship, public key and private key pair between a first user of a first peer node and a second user using a second peer node, said relationship established upon the first user sending a request to the second user wherein upon receipt of the request, said second user can elect to accept or decline said request, wherein upon acceptance of said request a second one-way relationship is established between the first user and second user that allows said first user and said second user to share store data stored on the first and second peer nodes of the first user and second users; and wherein a second one-way relationship between the first user and the second user comprises a public key and a private key pair and wherein the public key and private key one-way relationship pair converts a text string into a memory structure and the pair creates a corresponding array to create a first set of unmodified query pairs of electronic digital information request results to be stored in a data repository that is not located in a central server and may be configured locally; and
providing a user feedback modified second set of request query pairs of electronic digital information request results to be displayed.

32. A computer system for providing a social network based peer computing system, based on a first user's request secure query pair and decrypted system settings in a heterogeneous enterprise search environment, comprising:
a computer that is coupled to a digital telecommunications network by a digital telecommunications link to form a network of said computers;
an electronic digital memory in the computer; one or more sequences of computer program instructions stored in the electronic digital memory which, when executed, cause the computer to perform the steps of:
providing a first set of unmodified document query pairs of electronic digital information search results to be stored in a data repository;
providing a user feedback modified second set of document query pairs of electronic digital information search results to be displayed;
creating a social networking secure peer to peer array algorithm as a combination function comprising a plurality of step functions, said step functions specified by different user feature sets of sub-query user personalized preferences; and
replicating the first user's query pair and decrypted system settings in a heterogeneous enterprise search environment with one or more associated devices to create one public/private key pair, one or more devices corresponding to one or more persons and a plurality of attempted connections.

33. The computer system for providing a social network based peer computing system, based on a first user's request secure query pair and decrypted system settings in a heterogeneous enterprise search environment of claim 32, further comprising:
the first user and an associated second user in a friend relationship with a payment system, allowing both users sets of one or more devices to trade transaction data; and
transaction data comprising a payment amount, transaction identifier, and corresponding bank account information necessary for completing an e-commerce online, encrypted transaction.

34. The computer system for providing a social network based peer computing system, based on a first user's request secure query pair and decrypted system settings in a heterogeneous enterprise search environment of claim 33, further comprising:
merchant banking information to a purchaser wherein the merchant and purchaser are in a public key/private key, friend relationship;
merchant banking data from the purchaser's one or more synchronized devices to the purchaser's bank;
a deposit into the merchant's associated friend transaction bank account, using the associated e-commerce friend transaction data;
a transaction identifier string of characters randomly generated by the merchant device;
an associated transaction description and other text containing fields placed to be immediately accessible by the merchant device to verify that a deposit has been made for the current friend transaction; and
a verification of the transaction utilizing the corresponding transaction identifier and purchase amount to determine that the transaction is complete.

35. The computer system for providing a social network based peer computing system, based on a first user's request secure query pair and decrypted system settings in a heterogeneous enterprise search environment of claim 34, based on a first user's request query in a secure, decrypted system in a heterogeneous enterprise search environment, further comprising: one or more algorithms based on user personalized preference settings and one or more privacy profiles in an enterprise electronic data processing system network of computers, comprising: a computer readable storage medium; computer program instructions, recorded on the computer readable storage medium, executable by a processor, further comprising:
user selected electronic digital information query results to be displayed; and
one or more social network based peer computing system algorithms as combination functions that comprise one or more security factors, said security factors specified by different user selected weighting values corresponding to a plurality of user personalized preferences and one or more privacy profiles, said privacy profiles specified by various user selected weighting values corresponding to one or more privacy profiles.

36. A computer-implemented method for providing a social network based peer computing system algorithms based on customer's settings in a heterogeneous enterprise search environment system, the method comprising:
providing user selected electronic digital information search results to be displayed;
creating a social network based peer computing system algorithm as a combination function comprising a plurality of security factors, said security factors specified by different user selected weights corresponding to a plurality of user personalized preferences;
defining said security factors to indicate user defined document attributes and user defined preference weighting values;
first classifying a first grouping of security factors in a subset known to the search system;
first classifying a second grouping of security factors in a subset unknown to the search system, wherein said first and second grouping of security factors determine whether said security factor is known to the search system;
second classifying a first grouping of security factors in a subset that corresponds to whether said social network based peer computing system is dependent on said query;
creating a social networking secure peer to peer array algorithm as a combination function comprising a plurality of step functions, said step functions specified by different user feature sets of sub-query user personalized preferences;
replicating the first user's query pair and decrypted system settings in a heterogeneous enterprise search environment with one or more associated devices to create one public/private key pair, one or more devices corresponding to one or more persons and a plurality of attempted connections;
providing merchant banking information to a purchaser wherein the merchant and purchaser are in a public key/private key, friend relationship;
sending merchant banking data from the purchaser's one or more synchronized devices to the purchaser's bank;
making a deposit into the merchant's associated friend transaction bank account, using the associated e-commerce friend transaction data;
randomly generating a transaction identifier string of characters by the merchant device;
associating an transaction description and other text containing fields placed to be immediately accessible by the merchant device to verify that a deposit has been made for the current friend transaction; and
verifying of the transaction utilizing the corresponding transaction identifier and purchase amount to determine that the transaction is complete.

37. A system for providing a social network based peer computing system modeling in an object-oriented software environment, comprising:
a custom computer platform,
a plurality of peer nodes configured to implement a peer to peer environment on a network according to a peer to peer platform; wherein peer nodes connected to said social network based peer computing system are capable of sending and receiving data from other devices connected to the social network based peer computing system;
wherein at least a subset of the plurality of peer nodes is locally configured to store data specified by a user; and
wherein a first user of a first peer node establishes a relationship with a second user using a second peer node, said relationship established upon the first user sending a request to the second user;
wherein upon receipt of the request, said second user can elect to accept or decline said request, wherein upon acceptance of said request a relationship is established between the first user and second user that allows said first user and said second user to share store data stored on the first and second peer nodes of the first user and second users; and
wherein a one-way relationship between the first user and the second user comprises a public key and a private key pair and wherein the public key and private key one-way relationship pair converts a text string into a memory structure and the pair creates a corresponding array
one or more devices associated with a first user,
the one or more devices associated with a first user each having a root level object,
the one or more root level objects that are associated with the one or more devices associated with a first user each include a first device identified as a device 0, a second device identified as a device 1, and sequentially in the same pattern for the first user total associated devices in the peer to peer network,
the one or more root level objects further comprising a device information level including Internet Protocol (IP) addresses for each corresponding device other than the device 0 and friend information including a first friend identified as friend 0, a second friend identified as friend 1, and sequentially in the same pattern for the first user total associated devices not including the device 0 and the first user total associated friends not including the friend 0,
one or more device information data strings including device specific information corresponding to each first user device wherein the device information data string includes one or more data elements selected from the group consisting of reference device IP address, reference device protocol version, and connection information,
one or more associated friends corresponding to a first user wherein said one or more associated friends comprises corresponding one or more device information data strings,
wherein a first user with a multiplicity of devices is connected to one or more peer nodes, wherein each of said multiplicity of devices has established a public key/private key pair relationship with a second user, wherein said second user has at a multiplicity of devices connected to one or more peer nodes, wherein each of said multiplicity of devices is participating in the public key/private key pair relationship with each of said multiplicity of devices of said first user, wherein upon a first user updating stored data on at least one device said stored data is automatically migrated and replicated to the remaining multiplicity of devices of said first user, and wherein upon being updated each of said multiplicity of devices of said first user automatically migrates said stored data to each multiplicity of devices of said second user wherein said store data is then replicated on each of said multiplicity of devices of said second user,
a processor operable to execute instructions contained in computer program code,
at least one computer readable medium including steps for implementing a social network based peer computing system,
a computer program code providing programming language that is general purpose and object oriented, and
said computer program code for executing the mathematical algorithm represented using the programming language and solving the mathematical expressions.

38. A computer readable medium for a social network peer to peer structure, comprising:
(a) program code for sending a public key unencrypted;
(b) program code for holding locally a private key and object to be encrypted during transmission;
(c) program code for associating a first user with a second user wherein said first user has one or more corresponding devices and said second user has one or more corresponding devices;
(d) program code for associating device information for each user and corresponding devices of said user;
(e) program code for including one or more data elements to a corresponding device information data string;
(f) program code for generating a new public key/private key pair object representation and adding it to a first user's friend list;
(g) program code for attaching a first user's device information to a copy of the public key/private key pair object representation;
(h) program code for providing said object representation to a second user friend, said object representation selected from the list comprising a text file, an email, and a user-selected format;
(i) program code for providing an acceptance;
(j) program code for importing said object representation by a second user friend into a custom application wherein said second user friend now has said new public key/private key pair object representation; and
(k) program code for sending said object representation from a second user friend's first device to all remaining devices belonging to a second user.

39. A secure system for record synchronization of independent databases in an application platform peer to peer computer system, comprising:
a properly formatted file of secure alternative identifiers in a special table associated with a properly formatted file of friend requests that is performed in batch by a markup language web service,
a first user and an associated second user in a friend relationship with a payment system, allowing both users sets of one or more devices to trade transaction data,
transaction data comprising a payment amount, transaction identifier, and corresponding bank account information necessary for completing an e-commerce online, encrypted transaction, and
merchant banking information to a purchaser wherein the merchant and purchaser are in a public key/private key, friend relationship;
merchant banking data from the purchaser's one or more synchronized devices to the purchaser's bank;
a deposit into the merchant's associated friend transaction bank account, using the associated e-commerce friend transaction data;
a transaction identifier string of characters randomly generated by the merchant device;
an associated transaction description and other text containing fields placed to be immediately accessible by the merchant device to verify that a deposit has been made for the current friend transaction; and
a verification of the transaction utilizing the corresponding transaction identifier and purchase amount to determine that the transaction is complete.

40. One or more processor readable storage devices having processor readable code embodied on at least one processor readable storage device, said processor readable code for programming at least one processor to perform a method of making a friend comprising:
generating a new public key/private key pair object representation and adding it to a first user's friend list;
attaching a first user's device information to a copy of the public key/private key pair object representation;
providing said object representation to a second user friend, said object representation selected from the list comprising a text file, an email, and a user-selected format;
providing an acceptance;
importing said object representation by a second user friend into a custom application wherein said second user friend now has said new public key/private key pair object representation; and
sending said object representation from a second user friend's first device to all remaining devices belonging to a second user
providing a menu to a user in a machine readable markup language;
receiving one or more requests from the user for one or more encryption protected personal identifiers related to said user's one or more privacy filter data personal identifiers;
fetching said one or more encryption protected personal identifiers related to said user's one or more privacy filter data identifiers from a database;
formatting the one or more encryption protected personal identifiers related to said user's one or more privacy filter data identifiers into a markup language, and;
transmitting the markup language to the user wherein the one or more encryption protected personal identifiers related to said user's one or more privacy filter data identifiers comprises one or more aggregated database objects including one or more encryption protected personal identifiers related to said user's one or more privacy filter data identifiers, one or more third party augmented payment system database object tables, and at least one lockout security module wherein said at least one lockout security module is associated with at least one third party augmented payment system table.

41. A computer-implemented apparatus for providing a method of making a friend, said apparatus comprising:
a processor;
an input device coupled to said processor;
a memory coupled to said processor;
an output device; and
an execution engine including a method for making a friend comprising the following steps:
providing a plurality of peer nodes configured to implement a peer to peer environment on a network according to a peer to peer platform;
sending and receiving data from one or more devices wherein peer nodes are connected to the social network based peer computing system;
locally configuring a subset of a plurality of peer nodes wherein at least a subset of the plurality of peer nodes stored data specified by a user;
establishing a one-way relationship, public key and private key pair between a first user of a first peer node and a second user using a second peer node, said relationship established upon the first user sending a request to the second user wherein upon receipt of the request, said second user can elect to accept or decline said request, wherein upon acceptance of said request a second one-way relationship is established between the first user and second user that allows said first user and said second user to share store data stored on the first and second peer nodes of the first user and second users; and wherein a second one-way relationship between the first user and the second user comprises a public key and a private key pair and wherein the public key and private key one-way relationship pair converts a text string into a memory structure and the pair creates a corresponding array to create a first set of unmodified query pairs of electronic digital information request results to be stored in a data repository that is not located in a central server and may be configured locally; and
providing a user feedback modified second set of request query pairs of electronic digital information request results to be displayed.

42. A customizable application system comprising:
a secure peer to peer computer system application execution system for public key/private key social network and payment system configured to support preventing the submittal of the private key identifier to retrieve the properly formatted and encrypted locally held personal identifier to create a private key/public key pair, friend relationship;
a user interface generator operable to generate a secure synchronized data exchange application user interface including a secure data exchange interface element, the secure synchronized data exchange application user interface being configured for delivery to the user over a peer to peer computer network, the secure synchronized data exchange application element including a retrieve secure privacy filter identifier command;
metadata characterizing the one or more augmented friend relationship identifier table objects to create the one or more properly formatted personal identifier commands; wherein the user interface is operable to display an amount of data in response to a previously executed query,
a processor;
an input device coupled to said processor;
a memory coupled to said processor;
an output device; and
an execution engine including a method for providing a method of making a friend comprising the following steps:
providing a plurality of peer nodes configured to implement a peer to peer environment on a network according to a peer to peer platform;
sending and receiving data from one or more devices wherein peer nodes are connected to the social network based peer computing system;
locally configuring a subset of a plurality of peer nodes wherein at least a subset of the plurality of peer nodes stored data specified by a user; and
establishing a one-way relationship, public key and private key pair between a first user of a first peer node and a second user using a second peer node, said relationship established upon the first user sending a request to the second user wherein upon receipt of the request, said second user can elect to accept or decline said request, wherein upon acceptance of said request a second one-way relationship is established between the first user and second user that allows said first user and said second user to share store data stored on the first and second peer nodes of the first user and second users; and wherein a second one-way relationship between the first user and the second user comprises a public key and a private key pair and wherein the public key and private key one-way relationship pair converts a text string into a memory structure and the pair creates a corresponding array to create a first set of unmodified query pairs of electronic digital information request results to be stored in a data repository that is not located in a central server and may be configured locally; and
providing a user feedback modified second set of request query pairs of electronic digital information request results to be displayed

43. The customizable application system of claim 42, wherein the secure synchronized data exchange application user interface is configured for display at the secure synchronized data exchange application client using standard web browsing protocols.

44. A three party social network arrangement, comprising three relationship identifiers including a first user and a second user that share a private key-public key pair in a friend relationship and relate generally to a third party that does not share the public key-private key pair and is therefore not known to the first and second user and wherein the first and second user root level objects include a friends list and wherein propagating and replicating the three party social network comprises performing a query to search for common public keys using a party's device information in a first party and second user relationship.

45. The three party social network arrangement of claim 44, further comprising:
a query of device information data from one or more root level objects and associated nested friends lists in additional related level objects wherein the related objects create a third level list of contacts to invite as a new friend.

46. The three party social network arrangement of claim 45, further comprising:
a relationship identifier wherein a third party is unknown to the first and second user in the absence of a common public key and wherein a third party may not access or identify an individual in the social network.

47. The three party social network arrangement of claim 46, wherein each user has no link to a central database, server, and no account thereon and wherein each device in the social network contains a complete copy of the entire social network including its my device object data.

48. The three party social network arrangement of claim 47, further comprising:
a peer to peer network configuration in a closed enterprise environment wherein the relationship identifiers exist within a common, open source domain.

49. The three party social network arrangement of claim 48, wherein a friend or employee will have complete, real time contact information for every other friend or employee in the closed environment.

50. The three party social network arrangement of claim 49, wherein an organization chart is automatically generated and a complete suite of possible document, media, sharing and messaging is available in a fully implemented, private, secure, social network in the closed, enterprise environment.

51. A method for mapping an organizational chart, comprising:
traversing a complete social network;
evaluating one or more root level objects to identify common public key contact data;
evaluating one or more additional related level objects wherein the related objects create a third level list of contacts to invite as a new friend;
skipping friend relationships that have previously been evaluated in a higher level object when compared to the current level in a nested friends list;
skipping common public keys in a contact that has previously been evaluated in a higher level object;
parsing one or more objects to replace an existing friend object with an object received;
automatically generating an organization chart from the one or more friend relationships in an enterprise environment; and
replicating and synchronizing said organizational chart with one or more root level objects, one or more additional related level objects to comprise a complete copy of the entire enterprise social network.
